(19) United States
(12) Patent Application Publication
(10) Pub. No.: US 2011/0256024 A1
(43) Pub. Date: Oct. 20, 2011

(54) Modular Analyte Monitoring Device

(75) Inventors: Jean-Pierre Cole, Tracy, CA (US); Alexander G. Ghesquiere, San Francisco, CA (US); Jai Karan, Fremont, CA (US); Gary A. Hayter, Oakland, CA (US); Saeed Nekoomaram, San Mateo, CA (US)

(73) Assignee: Abbott Diabetes Care Inc.

(21) Appl. No.: 13/086,832

(22) Filed: Apr. 14, 2011

Related U.S. Application Data
(60) Provisional application No. 61/325,155, filed on Apr. 16, 2010.
(60) Provisional application No. 61/325,021, filed on Apr. 16, 2010.

(51) Int. Cl. B01J 19/00

(52) U.S. Cl. 422/68.1

(57) ABSTRACT

A modular analyte monitoring device comprising a base module and an attachment module is disclosed. The attachment module is removably coupled to the base module and includes a program storing component having a program update stored therein to be transmitted to the base module when coupled. The base module may thereafter operate using the program update.

### CROSS-REFERENCE TO RELATED APPLICATIONS

This application claims priority based on U.S. Provisional Application No. 61/325,155, filed Apr. 16, 2010 and U.S. Provisional Application No. 61/325,021, filed Apr. 16, 2010, the disclosures of which are herein incorporated by reference in their entirety.

### BACKGROUND OF THE INVENTION

Analyte monitoring devices have been used as medical diagnostic devices to determine a level of analyte from a sample. One common application is blood glucose measurements for diabetics. The diabetic typically pricks his or her finger using a lancet. A droplet of exposed blood is applied to a sensor on a test strip which is placed in the analyte monitoring device (in this case a glucose meter). A reading appears on a display of the measuring tool indicating the blood glucose level of the diabetic.

A variety of analyte monitoring devices with varying features and capabilities are manufactured for sale to users of the analyte monitoring device. For instance, one glucose meter may incorporate a strip port and an LCD display for displaying a measurement reading. However, another glucose meter may be manufactured to include a strip port, an LCD display, and a wireless transceiver. It is up to the user to decide which features and capabilities are desired and to purchase the appropriate analyte monitoring device with the desired features and capabilities.

In order to alter or create new features in an analyte test meter, manufacturers have to design and manufacture a new meter incorporating such altered or new features. The manufacture thus has to shelf not only the original analyte test meter, but also each new meter thereafter that it wishes to keep in production. This can be a burden to manufacturers not only in regards to cost, but also with regard to maintaining a wide range of models, designing frequently updated meters, and testing new features in the market place.

Moreover, if a user already has an existing analyte monitoring device but desires additional features and/or capabilities, then the user must purchase a different analyte monitoring device with the desired features. Furthermore, if the newly purchased analyte monitoring device has a different user interface than the one the user is accustomed to, then the user is further inconvenienced to have to acclimate to the new user interface. Buying an entirely new meter each time a new feature is desired can be inconvenient and costly for users.

### SUMMARY OF THE INVENTION

A modular analyte monitoring device comprising a base module and an attachment module is disclosed. The attachment module is removably coupled to the base module and includes a program storing component having a program update stored therein to be transmitted to the base module when coupled. The base module may thereafter operate using the program update.

These and other objects, advantages, and features of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIGS. 1A-1D illustrate a base module and attachment module that may be removably coupled to form an analyte monitoring device, according to some aspects;

FIGS. 2A-2D illustrate a base module and attachment module that may be removably coupled to form an analyte monitoring device, according to some aspects;

FIG. 3 illustrates a block diagram of an analyte monitoring device comprising a base module and an attachment module, according to some aspects;

FIGS. 4A-4B illustrate a top and bottom perspective view, respectively, of an analyte monitoring device, according to some aspects;

FIG. 5 illustrates a block diagram of a system including an analyte monitoring device comprising a base module and attachment module, according to some aspects;

FIG. 6 illustrates an analyte monitoring device used with an implantable sensor, according to some aspects;

FIG. 7 illustrates a block diagram of an analyte monitoring device comprising a base module and attachment module, according to some aspects; and

FIG. 8 illustrates a flowchart for a process of transmitting a program update, according to some aspects.

FIGS. 9A-9B illustrate perspective views of a base module and attachment module separated and removably coupled, respectively, according to some aspects;

FIG. 10A-10B illustrate perspective views of a base module and attachment module separated and removably coupled, respectively, according to some aspects; and

FIGS. 11A-11B illustrate perspective views of a base module and attachment module separated and removably coupled, respectively, according to some aspects.

FIG. 12 illustrates an analyte monitoring device communicating with various remote devices via a communication link, according to some aspects.

FIG. 13 illustrates a functional block diagram of an attachment module, according to some aspects.

### DETAILED DESCRIPTION OF THE INVENTION

Before the present inventions are described, it is to be understood that this invention is not limited to particular aspects described, as such may, of course, vary. It is also to be understood that the terminology used herein is for the purpose of describing particular aspects only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supercedes any disclosure of an incorporated publication to the extent there is a contradiction.

It must be noted that as used herein and in the appended claims, the singular forms “a”, “an”, and “the” include plural referents unless the context clearly dictates otherwise. Thus, for example, reference to “a program update” includes a plurality of such program updates and reference to “the program update” includes reference to one or more program updates and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present disclosure provides a modular analyte monitoring device comprising a base module and an attachment module. The attachment module is removably coupled to the base module. The base module comprises a housing and set of hardware components associated with determining an analyte level of a sample. The attachment module comprises a housing and a program storing component (e.g., a memory component with firmware and/or software stored therein). The program storing component includes program updates (e.g., firmware and/or software updates) to be transmitted to (and in some instances stored within) the base module as desired when the attachment module and base module are coupled. The attachment module may also include one or more additional hardware components providing additional features to the analyte monitoring device. In some instances, any firmware necessary for the base module to operate with the additional features is included in the program update for transmitting to the base module.

A base module for coupling to an attachment module to form an analyte monitoring device is provided. In some instances, the base module comprises a housing, a strip port unit coupled to the housing, and physical interface for removably coupling the attachment module to the base module. The base module is configured to receive and store a program update from the attachment module when coupled.

An attachment module for coupling to a base module to form an analyte monitoring device is also provided. In some instances, the attachment module comprises a housing and a physical interface. The physical interface is for removably coupling the attachment module to the base module configured for determining an analyte level of a sample and including a strip port unit. The attachment module also includes a program storing component coupled to the housing. The program storing component includes a program update stored therein to be transmitted to the base module when coupled.

An analyte monitoring device is also provided. The analyte monitoring device comprises a base module and attachment module. In some instances, the comprising a first housing, a strip port unit coupled to the first housing, and a first physical interface. The attachment module is removably coupled to the base module and comprises a second housing and a second physical interface. The first and second physical interfaces are for removably coupling the attachment module to the base module. The attachment module also comprises a program storing component coupled to the housing. The program storing component includes a program update stored therein to be transmitted and stored into the base module when coupled.

In some instances, the analyte monitoring device is a glucose meter used to determine the glucose level of a sample. Some references and examples are provided for a glucose meter and blood sample. It should be understood that the present disclosure is applicable to other analytes, as well as other sample types (e.g., interstitial fluid, sweat, urine, tears, saliva, dermal fluid, spinal fluid, etc.).

In some instances, the base module may require the coupling of the attachment module to operate as a functional analyte monitoring device. As one example, the base module may receive its primary power for operation from the attachment module.

In some instances, the base module does not require the attachment module to operate functionally as an analyte monitoring device—i.e., to perform at least the basic function of determining an analyte level of a sample and conveying it to the user. An attachment module, having additional hardware components associated with additional features, may be removably coupled to the base module to provide an analyte monitoring device with those additional features.

As stated above, the attachment module is removably coupled to the base module. It should be understood that the base module and the attachment module are removably coupled to one another. Therefore, in this disclosure, references to the attachment module removably coupled to the base module; references of the base module removably coupled to the attachment module; and references to the base module and attachment module removably coupled, are used interchangeably. Furthermore, when it is said that the devices are “coupled”, it is meant that the two modules are currently coupled (but are still removably coupled).

A physical interface on the housing of the base module and a physical interface on the housing of the attachment module are configured to releasably engage with one another to form a single, hand-held unit. The physical interfaces may be described in the present disclosure as being “on the housing”, which is meant to encompass a physical interface coupled to the housing and a physical interface formed within the housing. The physical interface describes generally the region of the housing that physically interfaces to the housing of the opposing module.

The physical interfaces may be removably coupled to one another by incorporating any of a variety of releasably engaging mechanisms—e.g., snap, slide, magnetic, Velcro, clasp, hook, hinge, etc. The physical interfaces, as well as the overall housing of the two modules, may be form fitted to provide a close fit for sturdy coupling, as well as to provide aesthetically desired housing contours when coupled as a single unit (e.g., coupled to form a slim rectangular unit).

In some instances, physical interfaces for the modules may be configured to include a module interface unit for communicating between modules. Module interface units may include electrical contacts that come in contact with one another when the two modules are coupled. Program updates that are to be transmitted from the attachment module to the base module (e.g., transmitted to the base module and stored therein) may, for example, be transmitted via the communication path formed by the electrical contacts. In some instances, physical interfaces may not include electrical contacts, wherein base module and attachment module communicate wirelessly with one another, for example.

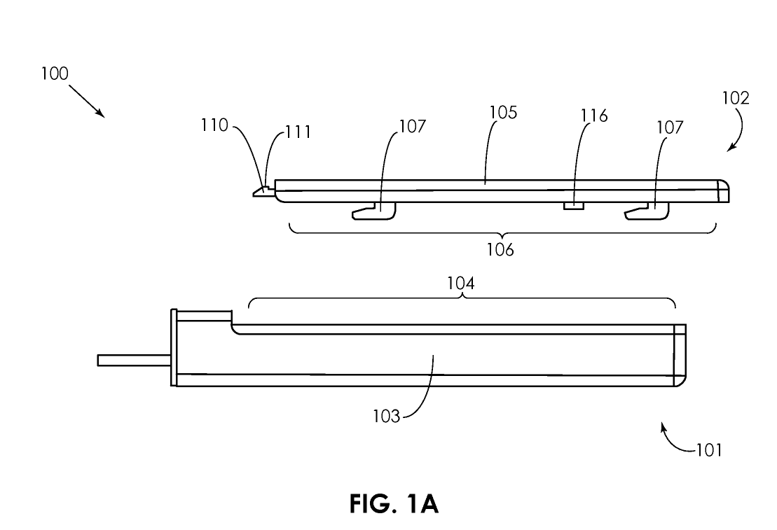

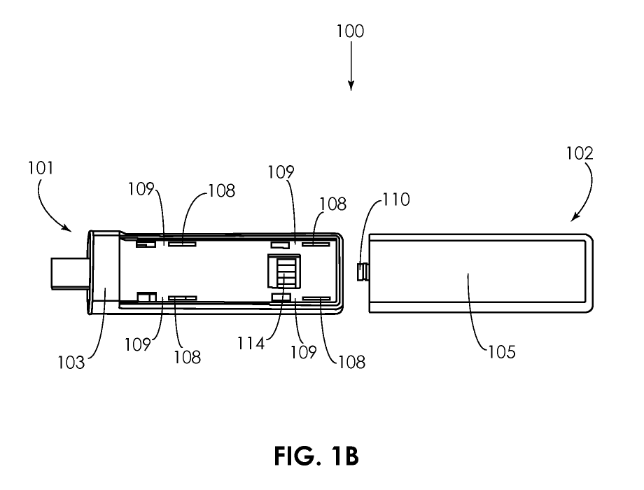

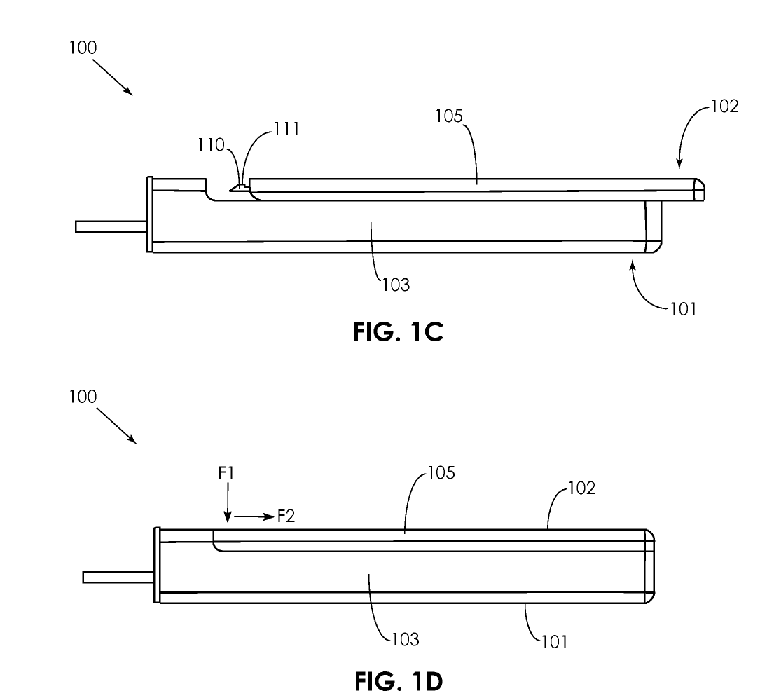

FIGS. 1A-1D illustrate a base module and attachment module that may be removably coupled to form an analyte monitoring device, according some aspects. FIGS. 1A-1B illustrate a side view and bottom view of a base module and attachment module, respectively, when not coupled. Analyte monitoring device 100 comprises base module 101 and attachment module 102. Base module 101 includes housing 103 and physical interface 104. Attachment module includes housing 105 and physical interface 106. Physical interfaces 104 and 106 are form-fitted and releasably engage with each other. Physical interface 106 includes protrusions 107 which mate with recesses 108 of physical interface 104. FIG. 1C illustrates the base module 101 and attachment module 102 brought together at physical interfaces 104 and 106. Protrusions 107 of attachment module 102 are inserted into recesses 108 of base module 101. Recesses 108 are shown as grooves which allow protrusions 107 to slide, permitting the physical interface of attachment module 102 to slide along the physical interface of base module 101. Protrusions 107 slide behind stops 109 formed in housing 103 that prevent attachment module 102 from being moved orthogonally away from the physical interface of base module 101 as it is being coupled. When attachment module 102 is slid completely along the sliding plane of base module 101, protrusion 110 of attachment module 102 “snaps” into another recess (not shown) on base module 101. Protrusion 110 includes a lip 111 which releasably engages the stop (not shown) on base module 101, thus preventing the attachment module 102 from sliding backwards and becoming uncoupled. FIG. 1D illustrates analyte monitoring device 100 with the attachment module 102 coupled to the base module 101. The base module 101 and attachment module 102 form a slim and form-fitted hand-held analyte monitoring device when coupled.

To remove attachment module 102 from base module 101, user applies sufficient force to overcome lip 111 from being engaged, thus releasing protrusion 110 from the recess (not shown) on base module 101. This may involve a force against the attachment module 102 into the sliding plane (as represented by arrow F1) and along the sliding plane (as represented by F2). Attachment module 102 may then be slid all the way past stops 109 so that protrusions 107 may be removed from recesses 108.

Physical interfaces 104 and 106 also include electrical contacts 114 and 116, respectively, that are coupled to each respective housing. (The module interface units of each physical interface are represented by the electrical contacts). The physical interfaces 104 and 106 are configured such that electrical contacts 114 and 116 come in contact when the attachment module 101 is coupled to the base module 102. This provides for a communication path between the base module 101 and attachment module 102.

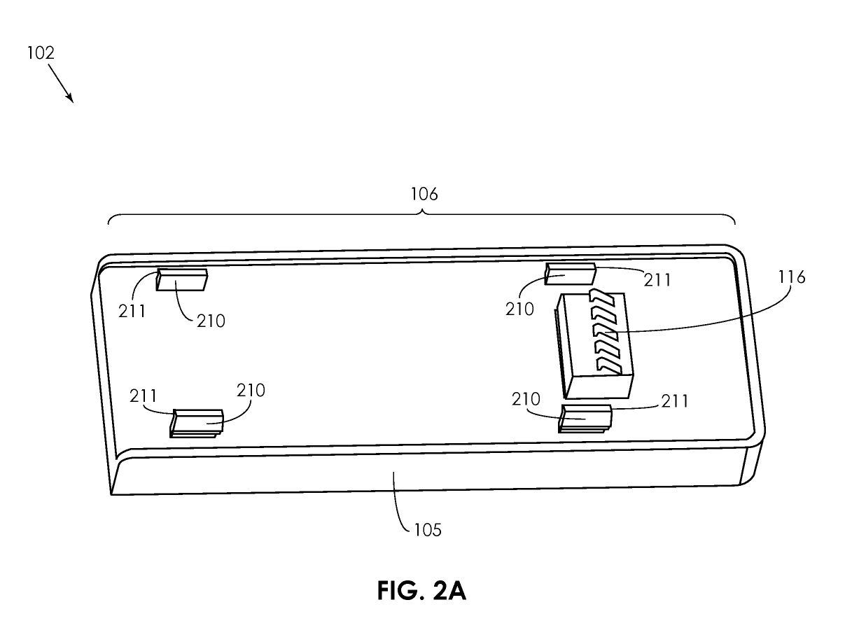

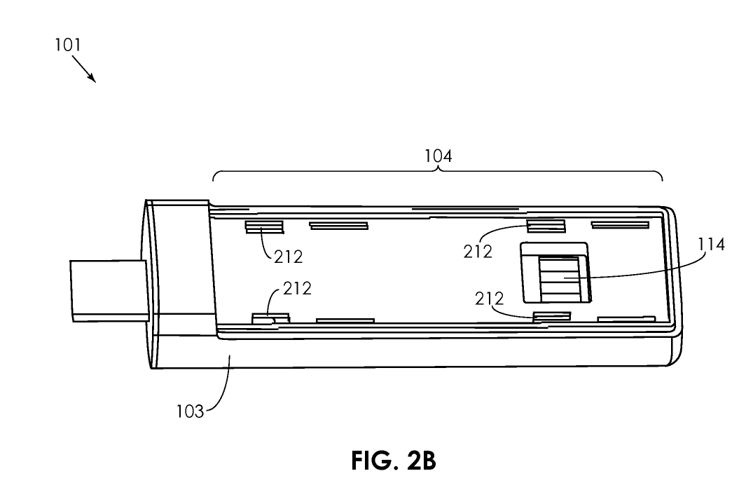

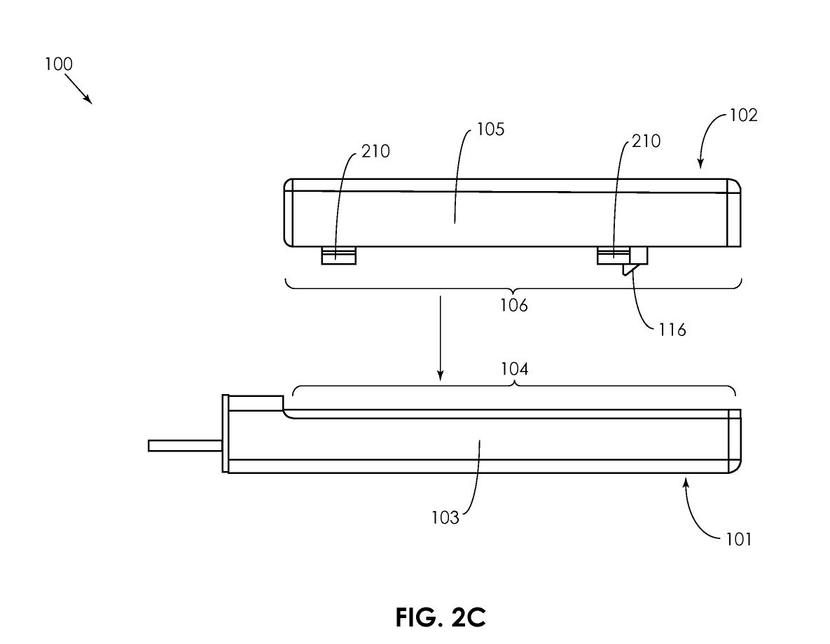

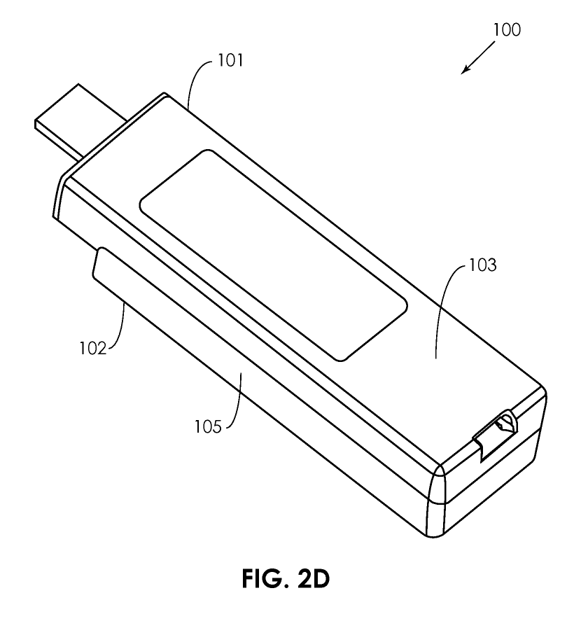

FIGS. 2A-2D illustrate a base module and attachment module that may be removably coupled to form an analyte monitoring device, according to some aspects. FIGS. 2A-2B illustrate a perspective view of attachment module and base module, respectively. Analyte monitoring device 100 comprises base module 101 and attachment module 102. Base module 101 includes housing 103 and physical interface 104. Attachment module includes housing 105 and physical interface 106. Protrusions 210 of attachment module 102 are configured to “snap” into recesses 212 of base module 101 when lips 211 on protrusions 210 releasably engage the portion of housing 103 which defines recesses 212. The attachment module 102 is brought towards the base module 101, as illustrated by arrow F3 in FIG. 2C, and does not require any sliding motion to couple. Electrical contacts 114 on physical interface 104 come into contact with electrical contacts 116 on physical interface 106 when the base module 101 is coupled to the attachment module 102, allowing a communication path to be formed between the two modules. As illustrated in FIG. 2D, base module 101 and attachment module 102 form a slim and form-fitted hand-held analyte monitoring device when coupled.

To remove the attachment module 102 from the base module 101, the user pulls the attachment module 102 away from base module 101 with enough force to overcome the lips 211 from being engaged, thus releasing protrusions 210 from recesses 212.

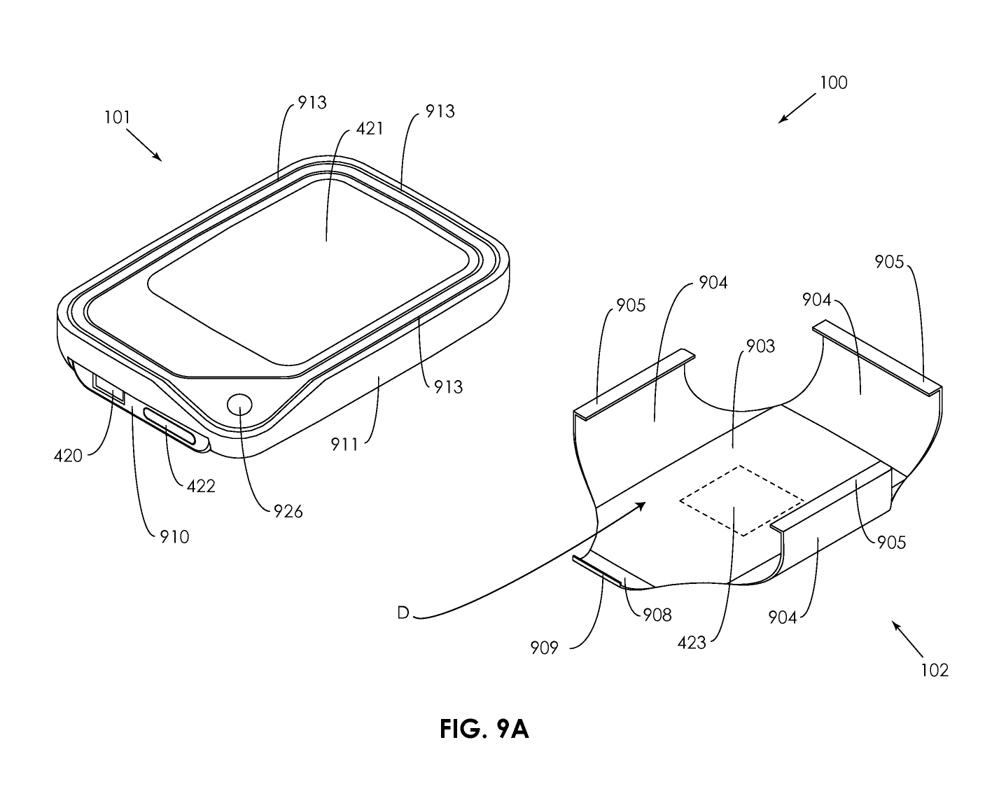

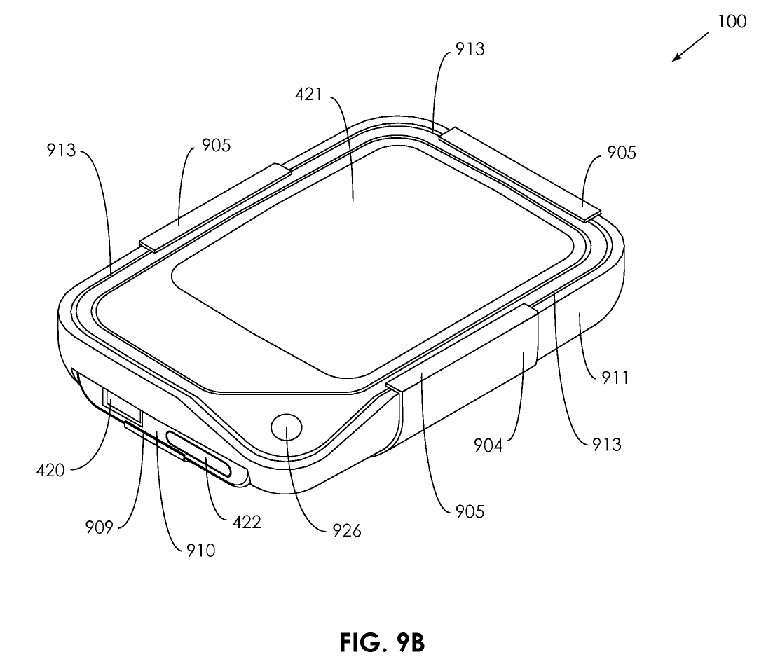

It should be understood that the aspects illustrated in FIGS. 1A-1D and FIGS. 2A-2D are exemplary, and that the base module and attachment module may be configured with any variety of releasably engaging mechanisms. For example, the example analyte monitoring devices shown for FIGS. 9-11, and described in detail later, show various other releaseably engaging mechanisms.

It should be understood that the base module may have a variety of shapes depending on particular design considerations. For example, the analyte monitoring device may be sized large enough for the user to handle comfortably. The analyte monitoring device may be configured large enough to allow the user to use and interact with any input elements and/or graphical displays. The base module and attachment module may be form fitted to produce an analyte monitoring device with a slim rectangular design. A thin design, for example, makes the analyte monitoring device more compatible with multiple USB receptacles that are stacked one above another on a remote device, when a communication connector unit is included within the meter (such as described in further detail below). The strip port and the communication connector may, for example, be located distant from one another to facilitate the measurement process for the user by providing additional space between the strip port and the remote device.

The modular architectural approach discussed herein provides many benefits. For example, with this architectural approach a basic analyte monitoring device (e.g., a base module and attachment module with basic features; and/or, a base module which does not require coupling of an attachment module to operate as a functional meter) can be produced and marketed that does not carry the cost burden of higher-end features or less common features, such as wireless connectivity, but allows users to add these features separately as needed. The basic meter receives the cost benefit of economy of scale, while the features provided by attachment modules can bear a cost appropriate for a lower volume. Further, the ability to add a variety of features as desired to the analyte monitoring device is achieved by creating an attachment module with the additional features and necessary firmware for use with the base module. Thus, various attachment modules with various features can be sold separately from the basic meter and may be added simply and conveniently by the user of the meter. With this architectural approach, when new capabilities are desired of an analyte monitoring device, an entirely new meter does not need to be designed and manufactured, taking up separate inventory shelf space from the original. Additionally, because the base module already exists in the market place and has been previously tested, new features can be more easily tested in user studies or in the market place through limited releases of the attachment module with the new feature. It should also be understood that improved base modules may also be manufactured with new features and firmware, and be configured to removably and operatively couple to the various attachment modules.

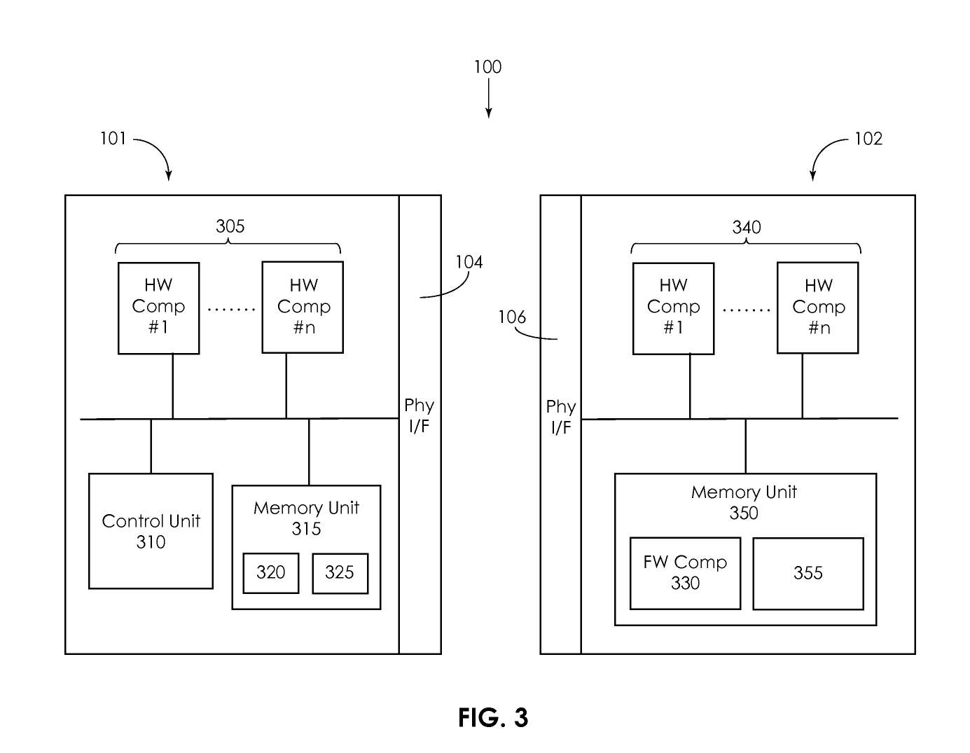

FIG. 3 illustrates a block diagram of an analyte monitoring device comprising a base module and attachment module, according to some aspects. As shown, analyte monitoring device 100 is comprised of base module 101 and attachment module 102. Base module 101 includes physical interface 104 and attachment module 102 includes physical interface 106.

Base module 101 is configured to include one or more hardware components 305 associated with determining an analyte level of a sample. For example, a base module may include hardware components such as a strip port unit and display unit.

The base module may further include, for example, a communication connector unit (e.g., a universal serial bus (USB) connector and associated circuitry) to communicate any test data to a remote device, such as a personal computer, laptop, PDA, cellular phone, smartphone, set-top box, etc. The term remote device is used herein to represent any device that is external to the analyte monitoring device. The base module may include a control unit 310 configured to, for example, control internal timing, perform various algorithms, result calculations, and to operate the hardware components 305.

Control unit 310 may, for example, include any type of processing device, such as a microprocessor and/or microcontroller. Memory unit 315 is coupled to control unit 310 and includes firmware necessary for operation of the base module and hardware components for determination of the analyte level.

Memory unit 315 refers broadly to any variety of memory (e.g., volatile, non-volatile, etc.), and may include one or more memory components. Memory unit 315 is shown to include program storing component 320 (e.g., Flash memory or other non-volatile media) for storing firmware (and any program updates received by the attachment module, for example), and may further include additional memory 325 (e.g., volatile memory such as random access memory (RAM) and/or non-volatile memory).

Additional information regarding analyte monitoring devices including a control unit configured to process signals received from analyte sensors (also referred to herein as test strips) to determine analyte levels from a sample are described in U.S. patent application Ser. No. 12/431,672, incorporated herein by reference.

Attachment module 102 is configured to include a program storing component 330 having firmware and/or software stored therein to be transmitted to base module 101, and in some instances, stored in base module 101 (e.g., in memory unit 315) after the attachment module102 is coupled to the base module 101. Program storing component 330 may also be, for example, flash or other non-volatile memory. In some aspects, memory unit 350 may also include additional memory 355 (e.g., volatile memory such as random access memory (RAM) and/or non-volatile memory).

Firmware and/or software stored in the attachment module 102 that is to be transmitted to base module 101 (and in some instances, stored within base module 101) is generally referred to herein as “program updates”. In some aspects, program updates may include firmware for updating the firmware currently stored in the base module 101 (e.g., a newer revision of firmware). The firmware currently stored in the base module 101 is also referred to herein as “current firmware”. Further, program updates may also include firmware for the base module 101 to operate using any additional hardware components 340 on the attachment module 102 so that the analyte monitoring device has the additional features associated with the hardware components 340. Thus, when the program update is transmitted to base module 101, base module 101 may thereafter operate using the features and hardware components 340 on the attachment module 102. For instance, hardware components 340 may include a wireless communication unit to provide the analyte monitoring device with wireless capabilities. It should be understood that the wireless communication unit may also include software components. Firmware for the base module 101 to operate using the wireless communication unit is included in the program update to be transmitted to base module 101, and for example stored in memory unit 315.

It should be appreciated that in some instances, the program update may be transmitted to the base module 101 for use by control unit 310 but not necessarily stored in base module 101. For example, in some instances, the base module 101 may access the program update stored in memory unit 350. In some instances, program update may be transmitted to the base module 101 and temporarily stored in volatile memory such as RAM or cache memory and used by control unit 310. In some instances, the program update may be transmitted to the base module 101 and stored within non-volatile memory (e.g., program storing component 320).

In some instances, the firmware from the attachment module may include a firmware “fix” to correct any bugs in the firmware on the base module. In such case, a potential issue may arise if a base module that has already received a firmware “fix” is coupled to an attachment module that has earlier firmware that does not yet account for the “fix”. A variety of safety checks may be implemented to avoid such potential issues. For example, the firmware “fix” may include a list of firmware revisions/updates which do not account for the “fix”. In this way, the base meter may be configured to recognize when an attachment module includes a program update (or portions of the program update) that should not be received and/or used to replace relevant firmware (or portions thereof) within the base module.

In some aspects, the program updates may also include various software and/or software updates and/or software fixes. For example, program updates may include instructions for executing various algorithms and meter-related functions (e.g., performing a bolus calculation, trending calculation, alert determination, etc.). In yet other aspects, the program update includes software, and/or software updates, and/or software fixes, without firmware.

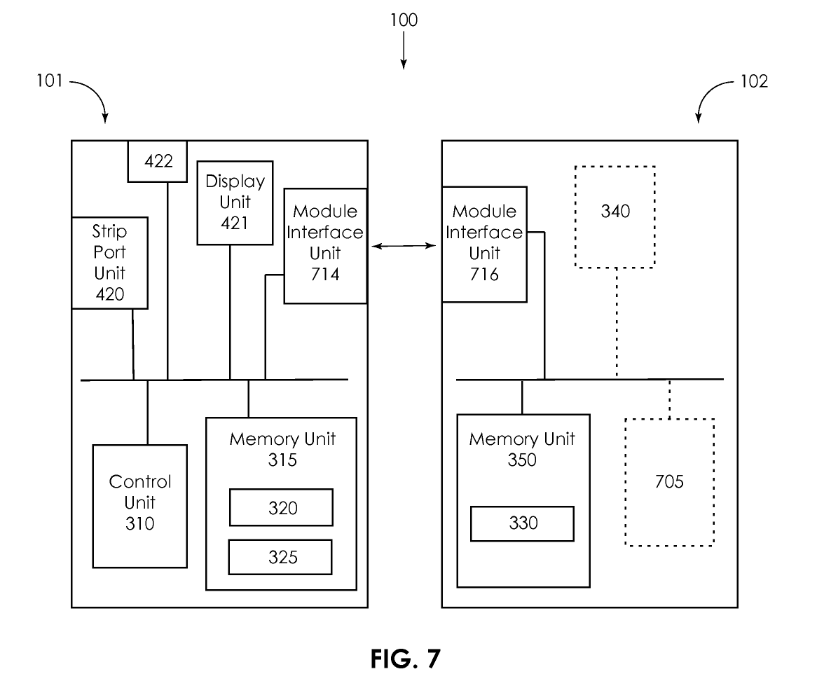

It should also be appreciated that in some instances, attachment module 102 may include a control unit (e.g., as shown in the embodiment shown in FIG. 7) while base module 101 may or may not include a control unit.

Various features may be provided to base module 101 by specific hardware components and associated features on the attachment module 102. This provides for a level of customizability depending on the hardware components and features available on each module.

Below various hardware components and associated features are described. It should be understood that the base module and the attachment module may include any of the features and respective hardware components described, or combinations thereof, however some features and components may make more practical sense on one particular module over the other, depending on the particular design considerations.

In some instances, a strip port unit may be coupled to the housing of the base module and/or attachment module. The strip port unit includes a strip port configured to receive analyte sensors (also referred to herein as test strips). It should be understood that the strip port may also include any associated circuitry for detection of the analyte within the sample. For example, the circuitry may include electrode contacts which couple to electrodes on the test strip, allowing current to be passed through the sample applied to the strip. The module designed with a strip port unit may also include additional hardware components required for providing a strip port light. This includes the lighting element (e.g., bulb, LED, etc.) and associated circuitry.

In some aspects, the strip port unit may include a sensor port (also referred to herein as a strip port) configured to receive analyte sensors having voltage-driven fill indicators. In some instances, the strip ports disclosed herein are configured to receive analyte sensors, e.g., analyte test strips, configured to include a voltage-driven fill indicator. An analyte sensor configured to include a voltage-driven fill indicator can include a fill-indicator which is visible at an end of the analyte sensor, e.g., an end of the analyte sensor other than an end which is inserted into the analyte monitoring device during the analyte measurement process. In some instances, the inclusion of a voltage-driven fill indicator can be implemented using a film which darkens or changes color when sufficient voltage is applied to it. An additional electrode can be included in the analyte sensor which is configured to make electrical contact with the film. The film can be variously positioned on the analyte sensor including, e.g., at an end of the analyte sensor.

An analyte monitoring device configured to receive an analyte sensor including a voltage-driven fill indicator can be configured to sense when the analyte sensor is sufficiently full of liquid (e.g., blood). This can be accomplished, for example, through the use of strip port contacts configured to contact a pair of fill-indicator electrodes. Additional description of fill-indicator electrodes is provided below and in the materials incorporated by reference herein. The analyte monitoring device can be configured such that when the analyte monitoring device senses that the analyte sensor is sufficiently full of liquid, it applies a voltage to an electrochromic film positioned between the additional electrode and a ground electrode. The film is selected such that the voltage applied by the analyte monitoring device is sufficient to darken the film or effect a change in its color. A variety of films and other electrochromic materials capable of darkening and/or changing color in response to an applied voltage are known in the art, including, e.g., polyaniline, viologens, polyoxotungstates and tungsten oxide. Additional description of an electrochromic film is provided, for example, in U.S. Patent Application No. 2007/0153355, the disclosure of which is incorporated by reference herein. Accordingly, a visual indication of analyte sensor fill can be provided.

While not required to be on the base module, in some instances, the strip port may be included in the base module because the strip port is a basic component required by typical monitoring device. In this way, each additional attachment module does not require the additional cost of a strip port.

Additional information related to strip ports and their configuration and operation in analyte monitoring devices is described in U.S. patent application Ser. No. 12/431,672, and in the U.S. patent application Ser. No. 12/695,947 entitled “Universal Test Strip Port”, filed on Jan. 28, 2010, the entirety of each of which is incorporated herein by reference.

In some instances, a strip port as disclosed herein is optionally configured as a fluid-wicking strip port interface. In some such instances, the strip port is configured to include one or more hydrophilic and/or absorptive materials positioned in proximity to an opening in the strip port, wherein the opening is configured to receive an analyte sensor, e.g., an analyte test strip. The hydrophilic and/or absorptive materials may be positioned, for example, surrounding or substantially surrounding the opening in the strip port. In some instances, the one or more hydrophilic and/or absorptive materials are positioned above and/or below the strip port opening. In other instances, the one or more hydrophilic and/or absorptive materials are positioned to the left and/or right of the strip port opening. In some instances, the one or more hydrophilic and/or absorptive materials define at least a portion of the opening in the strip port.

In certain instances, one or more, e.g., 2, rotating absorptive guards are positioned in relation to the strip port opening (e.g., directly above and/or below the strip port opening) such that during insertion of an analyte sensor, e.g., an analyte test strip, the absorptive guards each rotate while making contact with the analyte sensor. The rotating absorptive guards can be configured to engage the strip port housing or the analyte monitoring device housing, e.g., by engaging one or more shafts positioned on the strip port housing or the analyte monitoring device housing. The rotating action of the absorptive guards, e.g., about the one or more shafts, can mitigate added resistance which may be experienced by the user as a result of contact between the analyte sensor and the one or more absorptive guards as the user inserts the analyte sensor into the strip port. In some instances, once the analyte sensor is inserted, the absorptive guards form a barrier at the point or points of contact with the analyte sensor such that unwanted or excess fluid is prevented or at least substantially inhibited from entering the strip port opening. The one or more rotating absorptive guards may be disposable and/or replaceable. For example, the absorptive guards may be configured such that they can be easily removed from the strip port for cleaning, disposal and/or replacement. In some instances, the rotating absorptive guards have a substantially cylindrical shape, however, an absorptive guard having any suitable shape may be utilized.

In some instances, a strip port configured as a fluid-wicking strip port interface includes one or more paths and/or channels sized for capillary action which are positioned relative to the opening in the strip port such that they facilitate the wicking of fluid away from the opening in the strip port. These one or more paths and/or channels may include a hydrophilic and/or absorptive material and/or coating. In some instances, the one or more paths and/or channels include a mechanism by which air, when displaced by fluid, can escape the one/or more paths and/or channels. For example, in some instances, the one/or more paths and/or channels connect to one/or more additional paths and/or channels which provide an opening to the external environment of a base module or attachment module which incorporates a strip port as described herein. In some instances, the one or more paths and/or channels are positioned to facilitate flow of fluid in the general direction of a gravitational force applied during the insertion process. In some instances, the one or more paths and/or channels terminate in a reservoir positioned, for example, in the housing of the strip port or the housing of the base module or attachment module configured to include the strip port.

In some instances, a fluid-wicking strip port interface is configured to provide one or more alternative paths for a fluid which are more energetically favorable than a path which would bring the fluid into the internal environment of the strip port through the opening in the strip port.

In some instances, the fluid-wicking portion of a fluid-wicking strip port interface according to the present disclosure is separately disposable and/or replaceable. In other instances, the fluid-wicking portion is physically integrated with the strip port housing and/or the housing of the base module or attachment module which includes a strip port according to the present disclosure such that the fluid-wicking portion is not configured to be separately disposable and/or replaceable.

In additional instances, the hydrophilic and/or absorptive material and/or coating may include a material which changes color when contacted with a fluid. This may provide, for example, an indication that excess fluid was subject to wicking action by the hydrophilic and/or absorptive material and/or coating.

While the fluid-wicking strip port interface has been described above with reference to the strip ports disclosed herein, it should be noted that the features of the fluid-wicking strip port interface may provide similar effects when used in connection with other openings in analyte monitoring devices, or openings in other devices. For example, the features of the fluid-wicking strip port interface may be used to prevent or inhibit fluid ingress into a battery compartment or communication port on the base module or attachment module.

In some instances, the base module and/or attachment module may include a display unit coupled to its housing. Display unit may be configured to include a display and/or a display port for coupling a monitor to the module. The display unit may display the sensor signals and/or results determined from the sensor signals including, for example, analyte concentration, rate of change of analyte concentration, and/or the exceeding of a threshold analyte concentration (indicating, for example, hypo- or hyperglycemia).

The display unit may be configured to include a dot-matrix display. In other aspects, other display types, such as liquid-crystal displays (LCD), plasma displays, light-emitting diode (LED) displays, or seven-segment displays, among others, may alternatively be used. The display may be monochromatic (e.g., black and white) or polychromatic (i.e., having a range of colors). The display unit can be configured to provide, an alphanumeric display, a graphical display, a video display, an audio display, a vibratory output, or combinations thereof. The display unit can also be configured to provide, for example, information related to a patient's current analyte concentration as well as predictive analyte concentrations, such as trending information.

In some aspects, display unit can be configured to include a touchscreen display where the patient may enter information or commands via the display area using, for example, a stylus, finger, or any other suitable input device, and where, the touchscreen is configured as the user interface in an icon or motion driven environment, for example. Further details regarding menus and input elements, and operations thereof, are provided in the exemplary embodiments.

An analyte monitoring device including a touch screen may include the same functions and basic design as an analyte monitoring device without a touchscreen. In some instances, a touchscreen analyte monitoring device would include a larger display unit compared to the display unit of an analyte monitoring device without a touchscreen in order to accommodate the extra area required for any touchscreen buttons that may be used.

In some aspects, the display is coupled to the housing of the base module. Although the display is not required to be on the base module, the display may be included as part of the base module so that each additional attachment module does not require the additional cost of a display. If the base module includes a display of a first technology (e.g., a basic and more cost effective display), then additional attachment modules are not required to include an additional display. However, attachment modules including a display of a different technology may be coupled to the base module to provide the additional capability of using the display using a different technology—e.g., touchscreen display. In such case, for example, the program update includes firmware for the base module to operate using the display on the attachment module.

In some instances, the analyte monitoring device does not have a display (i.e., is displayless). For example, the analyte monitoring device may not include a display unit, or in some instances, the display unit does not include a screen designed to display results visually, but rather, communicates results audibly to a user of the analyte monitoring device, e.g., via an integrated speaker, or via separate speakers through a headphone jack or Bluetooth® headset. It should be appreciated that in some instances, the attachment module may be configured to use the display unit on the base module as a user interface, and vice versa.

In some instances, the base module and/or attachment module may include input elements coupled to its housing that enable the user to make entries, selections, etc. In some instances, a touchscreen may be employed with or without input elements.

In some instances, the base module and/or attachment module may include a communication connector unit coupled to the housing. A communication connector unit may include a communication connector and associated circuitry. Various technologies may be employed. For example, the communication connector may be of any of the following technologies, or family of technologies (but not limited thereto): USB, FireWire, SPI, SDIO, RS-232 port, or any other suitable electrical connector to allow data communication between the analyte monitoring device and a remote device. The communication connector unit provides the capability to communicate with a remote device having an appropriate interface to operatively couple with the communication connector. In some aspects, the communication connector is configured to communicate with a smartphone such as an iPhone or Blackberry. It should also be understood that more than one communication connector unit may be implemented on the analyte monitoring device—e.g., multiple communication units on the base module and/or the attachment module.

It should be understood that the term “communication connector” is used in this disclosure to represent any variety of connection interfaces—e.g., male or female connection interfaces. Using USB as an example, the communication connector may be any of the variety of USB plugs or USB receptacles/ports. As USB receptacles are typically located on computer and other devices, a corresponding USB plug used as a communication connector will enable the module to be plugged directly into the USB receptacle, avoiding the use of cables. In other aspects, the appropriate USB receptacle may be used on the module to enable communication using a USB cable (similar to many other devices such as digital cameras, cellular phones, smartphones, etc.). It should be appreciated that the communication connector unit may in some instances implement a wireless technology, in which case the connection interfaces would be corresponding transmitters, receivers, and/or transceivers.

Various functional features may be performed using the communication connector unit. For example, the communication connector may be used to transfer test data from the analyte monitoring device to the remote device. The remote device may store the test data and/or further process the test data and/or combine the test data with other additional information. The test data may include more than just analyte measurements and may also include such things as user settings/preferences, logged data, medication dosage information, exercise data, analysis data, food consumption data, rate of change of analyte level, and/or the exceeding of a threshold analyte level, etc.

The remote device may also communicate the test data and/or any additional data (e.g., further processed test data) via a separate communication channel (wired or wirelessly) to a second remote device—e.g., at a physician's office, hospital, or third party site. The second remote device may be, for example, a personal computer, laptop, PDA, cellular phone, set-top box, etc. For instance, test data may be transferred from the analyte monitoring device to a user's personal computer, stored therein, and then transmitted to a distant server at a hospital via an internet connection on the personal computer. A physician at the hospital may then access and review the test data on the server. In some aspects, the analyte monitoring device may be configured to receive a program update from a remote device via the communication connector unit.

In some aspects, the communication connector unit is coupled to the housing of the base module. Although the communication connector is not required to be on the base module, in some instances, the communication connector may be included as part of the base module so that each additional attachment module does not require the additional cost of a communication connector. If the base module includes a communication connector of a first technology (e.g., USB plug), then additional attachment modules have the option of including additional capabilities such as wireless communication.

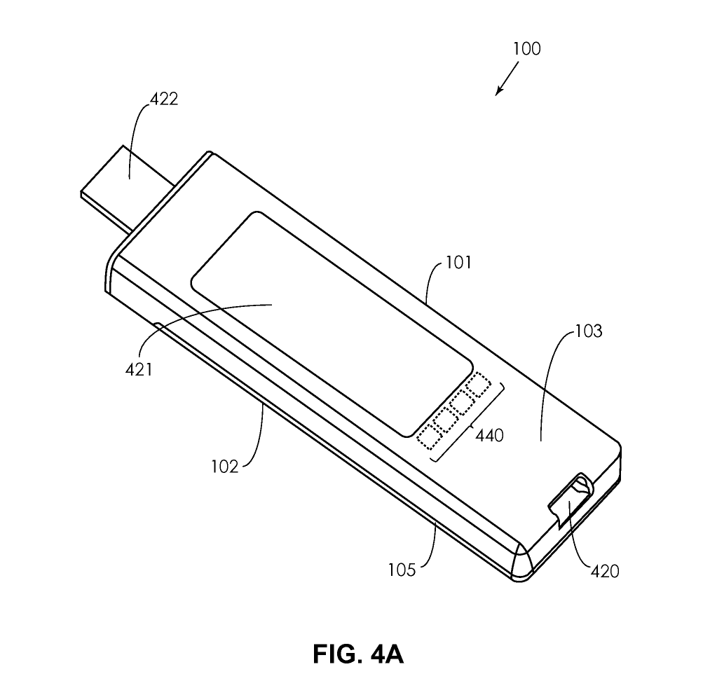

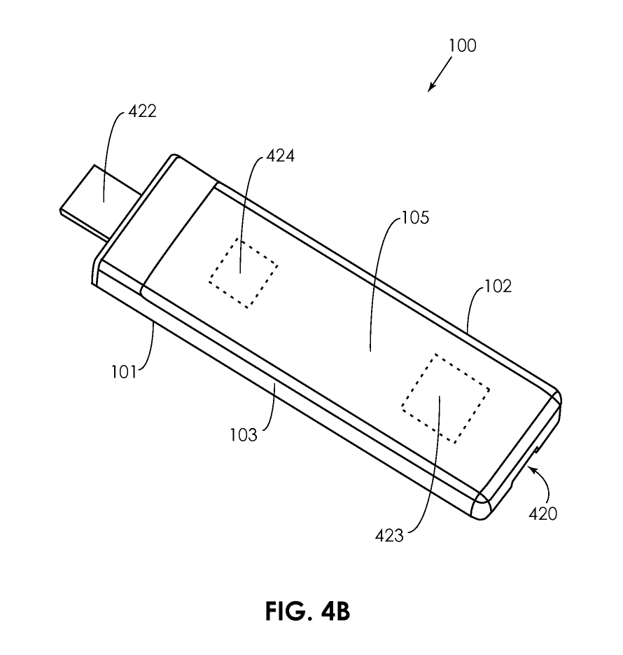

FIGS. 4A-B illustrate a top and bottom perspective view, respectively, of an analyte monitoring device, according to some aspects. Analyte monitoring device 100 is comprised of base module 101 and attachment module 102 removably coupled to base module 101. In this example, strip port unit 420 is coupled to the housing 103 of base module 101 at a strip port receiving end of the base module 101. Display 421 is a touchscreen display in this example and is coupled to housing 103 of base module 101 at a side of base module 101 opposite the coupled attachment module. Communication connector unit 422 of base module 101 includes a USB plug and is coupled to the housing 103 of base module 101 at an end opposite the strip port unit 420 in this example. Input elements 440 may also be present on the analyte monitoring device (e.g., on the base module 101, as represented by dotted lines 440) to enable the user to make entries, selections, etc. Input elements may include, but are not limited to: selection keys/arrows, dials, keypad, sliders, toggle switches, jog wheel, trackball, touchpad, pointing stick, capacitive sensing slider inputs, etc., or combinations thereof.

In some aspects, each input element is designated for a specific task. Alternatively, one or more of the input elements can be “soft” input elements. In the case where one or more of the plurality of input elements are “soft elements”, these buttons may be used for a variety of functions. The variety of functions may be determined based on the current mode of the analyte monitoring device, and may be distinguishable to a user by the use of button instructions shown on optional display unit 421 of analyte monitoring device 100.

In addition, in some aspects, the input element is configured such that a user can operate the input elements to adjust time and/or date information, as well as other features or settings associated with the operation of analyte monitoring device 100. For example, a user or patient can operate the input elements to perform calculations and determinations associated with one or more medication dose calculation functions, such as a bolus dose calculation function, of the analyte monitoring device 100, etc.

In some aspects, an input element 440 includes a microphone (not shown). Such a microphone can be utilized in connection with a voice-tagging function of an analyte monitoring device according to the present disclosure. For example, an analyte monitoring device according to the present disclosure can be configured to include a digital voice recorder which receives input from the microphone and stores digital voice files, e.g., as MP3 or WAV files. These digital voice files can be correlated with particular analyte measurement events to provide additional information which can be later reviewed, e.g., by the end user or a health care provider. For example, a user of the analyte monitoring device may choose to record a brief message regarding his/her state of health or food intake activity in proximity to (e.g., within a predetermined time period of) the time of a particular analyte measurement.

Attachment module 102 is configured to include program storing component 424 (represented by dotted lines) and a wireless communication unit 423 (represented by dotted lines) used to provide the analyte monitoring device with wireless capabilities. Firmware for the base module 101 to operate using the wireless communication unit 423 are stored in program storing component 424 and transmitted and stored into the base module 101 when coupled (e.g., via electrical contacts of module interface units on the physical interfaces of both modules—not shown).

It should be understood that the locations of the various hardware components presented herein are illustrative and may vary as desired, depending on particular design considerations. For example, display unit 421 to be on a side of the analyte monitoring device 100 which faces upwards when the analyte monitoring device 100 is connected to a remote device via communication connector unit 422. Also, strip port unit 420 may be designed away from the communication connector unit 422 to provide the user with sufficient distance from the remote device to facilitate placing a test strip into the strip port unit 420.

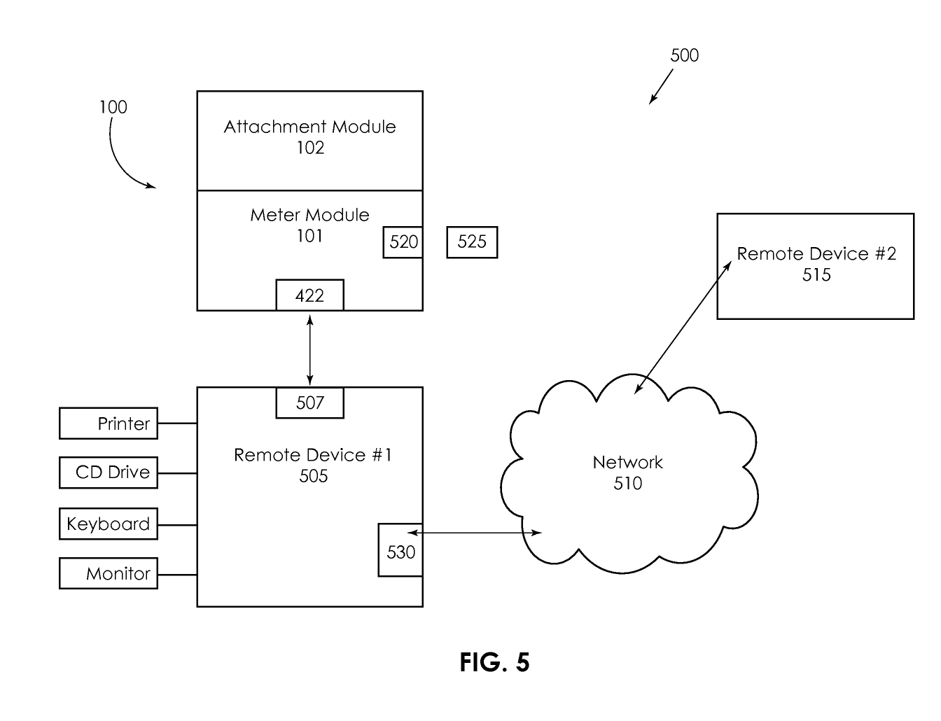

FIG. 5 illustrates a block diagram of a system including an analyte monitoring device comprising a base module and attachment module, according to some aspects. System 500 is shown to comprising analyte monitoring device 100 communicably coupled to remote device 505. Remote device 505 has network access to network 510 in which a second remote device 515 is shown coupled to. It should be understood that network 510 may include one or more networks, including LANs, WANs, and/or the internet.

Analyte monitoring device 100 is shown removably coupled to remote device 505 via communication connector unit 422 on base module 101. Communication connector unit, for example, includes a USB plug which couples with a USB receptacle 507 in remote device 505. Remote device 505 may include peripheral devices, such as printer, keyboard, monitor, CD drive, etc. Remote device 505 may also include, as shown, a network interface 530 which connects it to network 510. Remote device 515 is also connected to network 510 and may communicate with remote device 505 via network 510.

The following paragraphs describe system 500 during operation. In some instances, the analyte monitoring device described is a glucose monitoring device which measures the glucose concentration level of a blood sample. It should be understood that the description applies equally to other analytes and to other forms of samples.

In use, analyte monitoring device 100 receives a test strip 525 for measuring an analyte level of a sample applied to test strip 525. Test strip 525 is received at strip port unit 520 coupled to base module 101. Analyte monitoring device 100 performs a measurement computation on the sample and the user can view the measurement reading on, for example, a touchsreen display (not shown) coupled to the base module 101. The user may also be presented with a menu on the touchscreen display to view and select—e.g., menus for storing data, downloading data, performing bolus calculations based on the measurement, etc.

The user may couple the analyte monitoring device 100 to remote device 505 (e.g., a personal computer) via a communication connector unit. For example, the user may decide to store the measurement data and then choose to download stored test data (including stored measurement readings) to a remote device 505.

Analyte monitoring device 100 may then be coupled to remote device 505 via communication connector unit 422 on base module 101. Communication connector unit 422 may, for example, include a USB plug which couples to a USB receptacle 507 on remote device 505.

In some instances, the base module may be powered by the remote device 505 when coupled via the communication connector unit 422. In such case, the user would couple the analyte monitoring device 100 to the remote device 505 and then insert test strip 525 into the strip port 520 to take a measurement reading. In some instances, the analyte monitoring device includes its own power source, such as button or AAA-size batteries, for example, and is not powered by the remote device 505.

In some instances, the analyte monitoring device may be “locked” or prevented from performing a test while coupled to the remote device 505. For example, medical device regulations such as high voltage isolation testing may be required if the analyte monitoring device is configured to perform tests while coupled to a remote device. Thus, “locking” or preventing the analyte monitoring device from performing a test while coupled to the remote device allows the analyte monitoring device to not be subjected to the additional testing, if so desired.

In some aspects, the analyte monitoring device 100 may initiate a user interface application to execute on the analyte monitoring device, and/or the remote device 505 when coupled to the remote device 505. The user interface application may be stored in a memory unit on the base module 101. In some aspects, the user is not required to have previously loaded software on the remote device 505 to operate with the analyte monitoring device 100. In some aspects, the analyte monitoring device may be configured to initiate the user interface application automatically upon coupling to the remote device. It should be understood that the user interface application may be configured to be compatible with various hardware systems (e.g., PC, MAC) and various operating systems (e.g., Windows, MAC OS, Linux).

The user interface application may include, for example, diabetes management related applications. The user interface application may provide a variety of menus, selections, charts, alarms, reminders, visual indicators, etc. For example, the user may be presented with menus and options, such as whether to take a measurement reading, to view stored measurement readings, to store data, to download data, to perform bolus calculation based on the measurement, etc.

The user interface program may, for example, allow the user to perform the following steps: (1) create a replica of the test data stored on the analyte monitoring device 100, on the remote device 505; and (2) synchronize test data from the analyte monitoring device 100 to the database on the remote device 505. Meter settings and/or user settings/preferences from the analyte monitoring device may also be included in the test data and synchronized with the remote device. Date and time for the remote device 505 and analyte monitoring device 100 may also be synched.

To read test data from the analyte monitoring device 100 and write it to the remote device 505, it is recognized herein that data in the remote device may be organized into tables, which may be organized into records, which may be broken down into predefined fields. Similarly, at some level data will be organized into records with a consistent field structure on the analyte monitoring device 100. The user interface application may read test data from the analyte monitoring device and write it out to tables on the remote device 505. The user interface application may also read data from table in the remote device 505 and write them out to the analyte monitoring device 100. Various types of data conversion may be used. For example, data residing in fields in the analyte monitoring device may be converted from the format it exists in the analyte monitoring device to a format compatible with the remote device, and vice versa. The logical structure of the records in the two systems may be different.

Remote device 505 may include peripheral devices, such as printer, keyboard, monitor, CD drive, etc. Remote device 505 includes a network interface which connects it to network 510 (e.g., the internet). The user interface application may provide the user with the option to view test data on the monitor, to store test data on storage media (e.g., CD-ROM, memory card, etc.), further analyze and/or manipulate test data, transmit data to another device), and/or print out test data such as charts, reports, etc., on the printer.

As shown, remote device 505 may also include a network interface 530 (e.g., network interface card (NIC), modem, router, RF front end, etc.) used to connect the remote device 505 to network 510. For example, in some aspects, analyte monitoring device 100 may couple via a USB connection to the remote device which may be a personal computer or laptop connected to the internet using a wireless modem and/or router. In some aspects, analyte monitoring device 100 may couple via a micro USB connection to a remote device 505 which is a smartphone having an RF front end to access a mobile network. The user interface application may provide a user interface for using the network connection of the remote device 505—e.g., to forward test data to a physician, hospital, health provider, and/or other third party located at a second remote device 515 on network 510. Appropriate action may then be taken by the receiving party at the second remote device 515.

In some instances, the base module and/or attachment module may include a wireless communication unit. In such case, the wireless communication unit may provide the analyte monitoring device with wireless capabilities to communicate with other devices—e.g., with remote device 505.

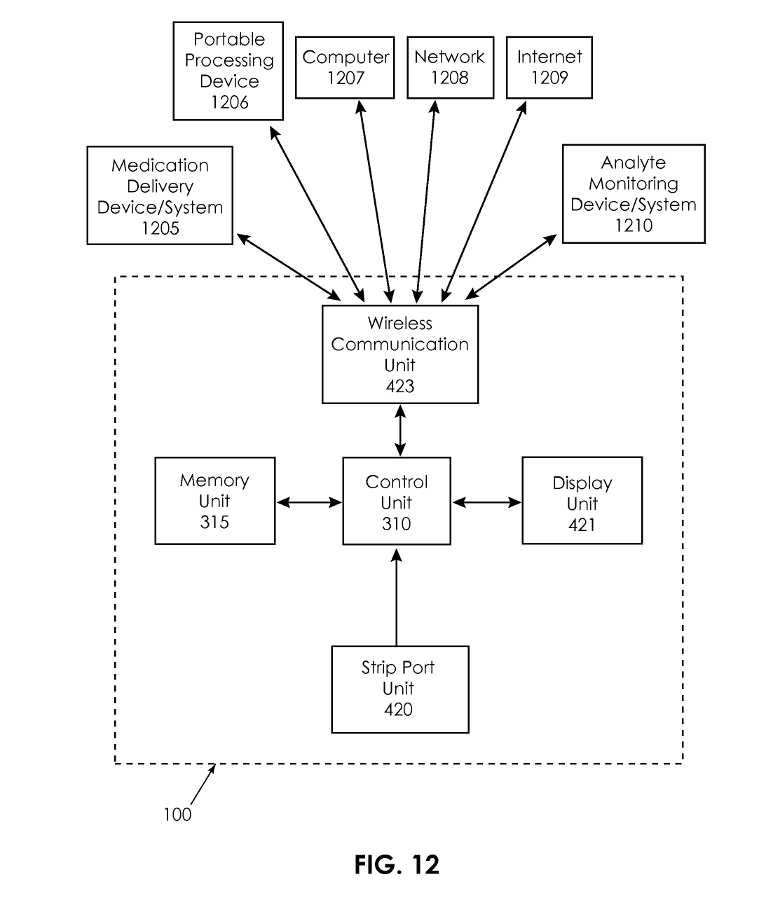

Looking ahead to FIG. 12, FIG. 12 illustrates an analyte monitoring device communicating with various remote devices via a communication link, according to some aspects. As shown, analyte monitoring device 100 includes control unit 310, memory 315, display unit 421 and strip port unit 420, as previously described above. As shown, wireless communication unit 423 (and/or communication connector unit 422 in some instances) can be configured to communicate with one or more remote devices—e.g., with one or more of a medication delivery device and/or system 1205, a portable processing device 1206, a computer 1207, a network 1208, an internet 1209 and an analyte monitoring device and/or system 1210 (e.g., a system including an implanted or partially implanted analyte sensor).

Referring back to FIG. 5, the wireless communication unit may include, for example, a receiver and/or transmitter for communicating with another device, e.g., remote device 505, a medication delivery device, and/or a patient monitoring device (e.g., a continuous glucose monitoring device or a health management system, such as the CoPilot™ system available from Abbott Diabetes Care Inc., Alameda, Calif.), etc. The wireless communication unit may be configured to wirelessly communicate using a technology including, but not limited to, radio frequency (RF) communication, Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM), etc. In some aspects, the wireless communication unit is configured for bi-directional radio frequency (RF) communication with another device to transmit and/or receive data to and from the analyte monitoring device 100.

In some aspects, the wireless communication unit may be used to communicate with a remote device as described above for the communication connector unit. In some aspects where the analyte monitoring device includes a communication connector unit, the wireless communication unit may replace or provide an optional channel of communication for the functions provided by the communication connector unit discussed above. Referring back to FIG. 5, analyte monitoring device 100 may be coupled to remote device 505 via a wireless communication unit of the attachment module 102 and provide an optional alternative communication channel with remote device 505. In some aspects, analyte monitoring device 100 may not include a communication connector unit 422, and instead only communicate with the remote device 505 via a wireless communication unit present on either the base module 101 or attachment module 102. In some aspects, the analyte monitoring device is configured to receive a program update from a remote device via the wireless communication unit.

In some aspects, the wireless communication module may be configured to communicate with a smartphone (e.g., iPhone, Blackberry, etc). It is typical for smartphones to include various wireless technologies such as Wi-Fi, infrared, Bluetooth®, etc.

In some aspects, the analyte monitoring device may be configured to wirelessly communicate via the wireless communication unit with a server device, e.g., using a common standard such as 802.11 or Bluetooth® RF protocol, or an IrDA infrared protocol. The server device could be another portable device, such as a Personal Digital Assistant (PDA) or notebook computer, or a larger device such as a desktop computer, appliance, etc. In some aspects, the server device has a display, such as a liquid crystal display (LCD), as well as an input device, such as buttons, a keyboard, mouse or touchscreen. With such an arrangement, the user can control the meter indirectly by interacting with the user interface(s) of the server device, which in turn interacts with the meter across a wireless link.

In some aspects, the wireless communication unit is not present on the base module and instead coupled to the housing of an attachment module. In this way, the base module does not require the cost of wireless capabilities, yet the wireless capabilities may be acquired by coupling an attachment module including a wireless communication unit. This provides flexibility and cost savings for both the manufacturers and users of the analyte monitoring devices.

In some aspects, the wireless communication module is used to communicate with a remote sensor—e.g., a sensor configured for implantation into a patient or user. Examples of sensors for use in the analyte monitoring systems of the invention are described in U.S. Pat. No. 6,175,752; and U.S. patent application Ser. No. 09/034,372, incorporated herein by reference. Additional information regarding sensors and continuous analyte monitoring systems and devices are described in U.S. Pat. No. 5,356,786; U.S. Pat. No. 6,175,752; U.S. Pat. No. 6,560,471; U.S. Pat. No. 5,262,035; U.S. Pat. No. 6,881,551; U.S. Pat. No. 6,121,009; U.S. Pat. No. 7,167,818; U.S. Pat. No. 6,270,455; U.S. Pat. No. 6,161,095; U.S. Pat. No. 5,918,603; U.S. Pat. No. 6,144,837; U.S. Pat. No. 5,601,435; U.S. Pat. No. 5,822,715; U.S. Pat. No. 5,899,855; U.S. Pat. No. 6,071,391; U.S. Pat. No. 6,120,676; U.S. Pat. No. 6,143,164; U.S. Pat. No. 6,299,757; U.S. Pat. No. 6,338,790; U.S. Pat. No. 6,377,894; U.S. Pat. No. 6,600,997; U.S. Pat. No. 6,773,671; U.S. Pat. No. 6,514,460; U.S. Pat. No. 6,592,745; U.S. Pat. No. 5,628,890; U.S. Pat. No. 5,820,551; U.S. Pat. No. 6,736,957; U.S. Pat. No. 4,545,382; U.S. Pat. No. 4,711,245; U.S. Pat. No. 5,509,410; U.S. Pat. No. 6,540,891; U.S. Pat. No. 6,730,100; U.S. Pat. No. 6,764,581; U.S. Pat. No. 6,299,757; U.S. Pat. No. 6,461,496; U.S. Pat. No. 6,503,381; U.S. Pat. No. 6,591,125; U.S. Pat. No. 6,616,819; U.S. Pat. No. 6,618,934; U.S. Pat. No. 6,676,816; U.S. Pat. No. 6,749,740; U.S. Pat. No. 6,893,545; U.S. Pat. No. 6,942,518; U.S. Pat. No. 6,514,718; U.S. Pat. No. 5,264,014; U.S. Pat. No. 5,262,305; U.S. Pat. No. 5,320,715; U.S. Pat. No. 5,593,852; U.S. Pat. No. 6,746,582; U.S. Pat. No. 6,284,478; U.S. Pat. No. 7,299,082; U.S. patent application Ser. No. 10/745,878 filed Dec. 26, 1003 entitled “Continuous Glucose Monitoring System and Methods of Use”; and U.S. Application No. 61/149,639 entitled “Compact On-Body Physiological Monitoring Device and Methods Thereof”, the disclosures of each which are incorporated by reference herein.

In some instances, the analyte monitoring device is part of a continuous analyte monitoring system, where a transcutaneously implanted sensor may continually or substantially continually measure an analyte concentration of a bodily fluid. Examples of such sensors and continuous analyte monitoring devices include systems and devices described in U.S. Pat. Nos. 6,175,752, 6,560,471, 5,262,305, 5,356,786, U.S. patent application Ser. No. 12/698,124 and U.S. provisional application No. 61/149,639 titled “Compact On-Body Physiological Monitoring Device and Methods Thereof”, the disclosures of each of which are incorporated herein by reference for all purposes.

Accordingly, in some aspects, the analyte monitoring device may be configured to operate or function as a data receiver or controller to receive analyte related data from a transcutaneously positioned in vivo analyte sensor such as an implantable glucose sensor. The analyte monitoring system may include a sensor, for example an in vivo analyte sensor configured for continuous or substantially continuous measurement of an analyte level of a body fluid, a data processing unit (e.g., sensor electronics) connectable to the sensor, and the analyte monitoring device configured to communicate with the data processing unit via a communication link (e.g., using the wireless communication module). In aspects of the present disclosure, the sensor and the data processing unit (sensor electronics) may be configured as a single integrated assembly. In some aspects, the integrated sensor and sensor electronics assembly may be configured as a compact, low profile on-body patch device assembled in a single integrated housing and positioned on a skin surface of the user or the patient with a portion of the analyte sensor maintained in fluid contact with a bodily fluid such as an interstitial fluid during the sensor life time period (for example, sensor life time period including about 5 days or more, or about 7 days or more, or about 14 days or more, or in certain instances, about 30 days or more). In such instances, the on-body patch device may be configured for, for example, RF communication with the analyte monitoring device to wirelessly provide monitored or detected analyte related data to the analyte monitoring device based on a predetermined transmission schedule or when requested from the analyte monitoring device. Predetermined transmission schedule may be programmed or configured to coincide with the analyte sample detection by the analyte sensor (for example, but not limited to including once every minute, once every 5 minutes, once every 15 minutes). Alternatively, the analyte monitoring device may be programmed or programmable to acquire the sampled analyte data (real time information and/or stored historical data) in response to one or more requests transmitted from the analyte monitoring device to the on-body patch device.

In some aspects, wireless communication module of the analyte monitoring device includes an RF receiver and an antenna that is configured to communicate with the data processing unit, and the processor of the analyte monitoring device is configured for processing the received data from the data processing unit such as data decoding, error detection and correction, data clock generation, and/or data bit recovery.

In operation, the analyte monitoring device in some aspects is configured to synchronize with the data processing unit to uniquely identify the data processing unit, based on, for example, an identification information of the data processing unit, and thereafter, to periodically receive signals transmitted from the data processing unit associated with the monitored analyte levels detected by the sensor.

In some aspects, the analyte monitoring device may also be configured to operate as a data logger, interacting or communicating with the on-body patch device by, for example, periodically transmitting requests for analyte level information from the on-body patch device, and storing the received analyte level information from the on-body patch device in one or more memory components.

In some aspects, when the analyte monitoring device is positioned or placed in close proximity or within a predetermined range of the on-body patch device, the RF power supply in the analyte monitoring device may be configured to provide the necessary power to operate the electronics in the on-body patch device, and accordingly, the on-body patch device may be configured to, upon detection of the RF power from the analyte monitoring device, perform preprogrammed routines including, for example, transmitting one or more signals to the analyte monitoring device indicative of the sampled analyte level measured by the analyte sensor. In one aspect, communication and/or RF power transfer between the analyte monitoring device and the on-body patch device may be automatically initiated when the analyte monitoring device is placed in close proximity to the on-body patch device. Alternatively, the analyte monitoring device may be configured such that user intervention, such as a confirmation request and subsequent confirmation by the user using, for example, the display and/or input components of the analyte monitoring device, may be required prior to the initiation of communication and/or RF power transfer between the analyte monitoring device and the on-body patch device. In a further aspect, the analyte monitoring device may be user configurable between multiple modes, such that the user may choose whether the communication between the analyte monitoring device and on-body patch device is performed automatically or requires a user confirmation.

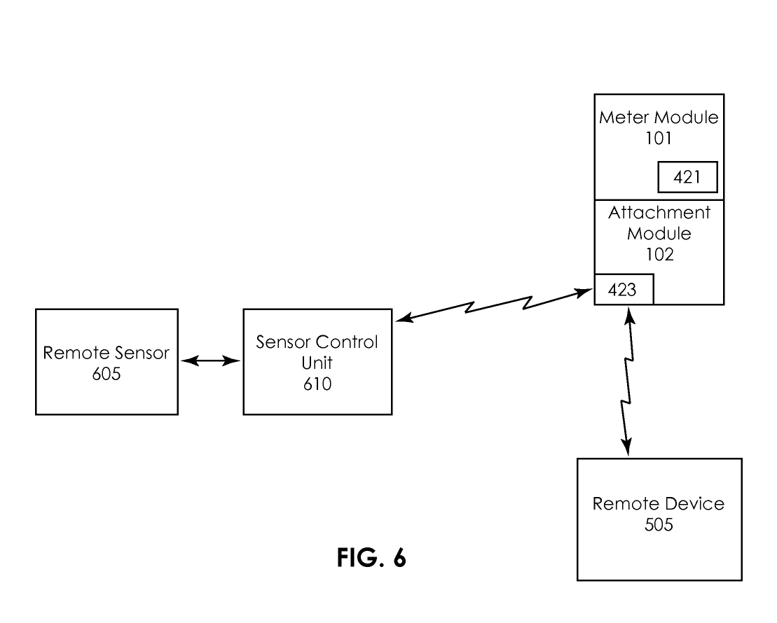

FIG. 6 illustrates an analyte monitoring device used with a remote sensor, according to some aspects. Analyte monitoring device 100 comprises attachment module 102 removably coupled to base module 101. Sensor 605 may be configured for implantation (e.g., subcutaneous, venous, or arterial implantation) into a patient. The sensor 605 is coupled to sensor control unit 610 which is typically attached to the skin of a patient. The sensor control unit 610 operates the sensor 605, including, for example, providing a voltage across the electrodes of the sensor 605 and collecting signals from the sensor 605. The sensor control unit 610 may evaluate the signals from the sensor 605 and/or transmit the signals to wireless communication unit 423 on analyte monitoring device 100 for evaluation.

In some aspects, the wireless communication unit 423 is configured to receive a signal from a remote sensor using radio-frequency identification (RFID) technology. This configuration may be used to provide glucose on demand capabilities, in which case when a measurement reading is desired, the analyte monitoring device is brought within close vicinity of the implantable sensor. In some instances, RFID technology may be used in continuous glucose monitoring (CGM) applications.

The analyte monitoring device 100 processes the signals from the on-skin sensor control unit 610 to determine the concentration or level of analyte in the subcutaneous tissue and may display the current level of the analyte via display unit 421. Furthermore, the sensor control unit 610 and/or the analyte monitoring device 100 may indicate to the patient, via, for example, an audible, visual, or other sensory-stimulating alarm, when the level of the analyte is at or near a threshold level. For example, if glucose is monitored then an alarm may be used to alert the patient to a hypoglycemic or hyperglycemic glucose level and/or to impending hypoglycemia or hyperglycemia.

The analyte monitoring device 100 may perform a variety of functions, including for example: modifying the signals from the sensor 605 using calibration data and/or measurements from a temperature probe (not shown); determining a level of an analyte in the interstitial fluid; determining a level of an analyte in the bloodstream based on the sensor measurements in the interstitial fluid; determining if the level, rate of change, and/or acceleration in the rate of change of the analyte exceeds or meets one or more threshold values; activating an alarm system if a threshold value is met or exceeded; evaluating trends in the level of an analyte based on a series of sensor signals; therapy management (e.g., determine a dose of a medication, etc.); and reduce noise or error contributions (e.g., through signal averaging or comparing readings from multiple electrodes); etc. The analyte monitoring device may be simple and perform only one or a small number of these functions or the analyte monitoring device may perform all or most of these functions.

Analyte monitoring device 100 may communicate with a remote device 505 via communication connector unit 422, and/or wireless communication unit 423, and/or a second wireless communication unit (not shown), as described earlier. It should also be understood that the analyte monitoring device may be configured with one or more wireless communication units. For instance, an attachment module may include a wireless communication unit which enables the analyte monitoring device to communicate wirelessly with a remote device using Bluetooth® technology; and include a second wireless communication unit that enables the analyte monitoring device to communicate wirelessly using RFID technology with an implantable sensor.

Looking ahead, FIGS. 9-11 illustrate an analyte monitoring device including an attachment module and base module, according to some aspects. For example, the attachment module may be configured to communicate with a remote device—e.g., a glucose on demand (GoD) device and/or continuous glucose monitoring (CGM) device.

FIGS. 9A-9B illustrate perspective views of a base module and attachment module separated and removably coupled, respectively, according to some aspects. As shown, analyte monitoring device 100 includes base module 101 and attachment module 102. Base module 101 is shown having a display 420 (e.g., touchscreen display), strip port unit 420, a communication connector unit 422 (e.g., USB port), and input element 926 (e.g., power button). Furthermore, base module 101 is shown having a housing 911 that includes a top outer surface 913, as well as a surface 910 at one end of the module 101.

Attachment module 102 is shown to include a housing base 903 that houses circuitry 423 included in the attachment module, as represented generally by the dotted lines for circuitry 423. Circuitry 423 may include, for example, a wireless communication module for communicating wirelessly using RF (e.g., RFID technology) to a remote device such as a GoD device and/or CGM device. Furthermore, circuitry 423 may include a wireless communication module for communicating wireless with the base module 101 (e.g., the same or different wireless communication module used to communicate with the GoD device and/or CGM device). For example, the wireless communication module may communicate with the base module using Bluetooth® technology. In this way, when coupled, the attachment module 102 may receive data (e.g., glucose readings) wirelessly from the GoD and/or CGM device and provide the information to the base module 101.

Housing arms 904,905 are shown extending from housing base 903 and include protrusions 906,909, respectively. Housing arms 904,905 function to secure the attachment module 102 to the base module 101. In the example shown, the base module 101 is configured to slide into the attachment module 102, as represented by directional arrow D shown in FIG. 9A. Base module 101 is inserted over housing arm 908 with outer top surface 913 positioned below protrusions 906 of housing arms 904. In this way, protrusions 906 function to guide and secure base module 101 to the attachment module 102. As the base module 101 is fully inserted into the attachment module 102, surface 910 of base module 101 slides past protrusion 909 of housing arm 908 and is secured by protrusion 909, as shown in FIG. 9B. Housing arm 908 may be slightly flexible, for instance, to flex as the base module slides over housing arm 908 upon engagement, and yet flex back to secure against surface 910 when base module 101 is fully inserted. Thus, the attachment module 102 is fully secured to the base module 101. To release the attachment device 102 from the base module 101, the user may press on protrusion 909 such that it flexes beyond surface 910 and allows base module 101 to slide back out of the attachment module 102.

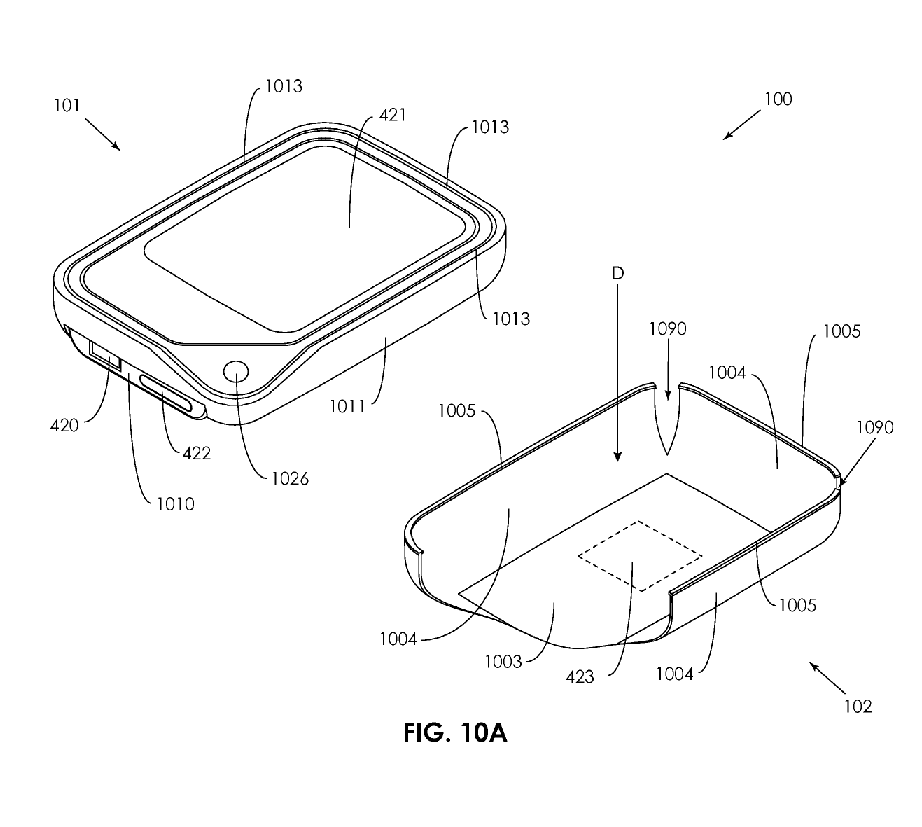

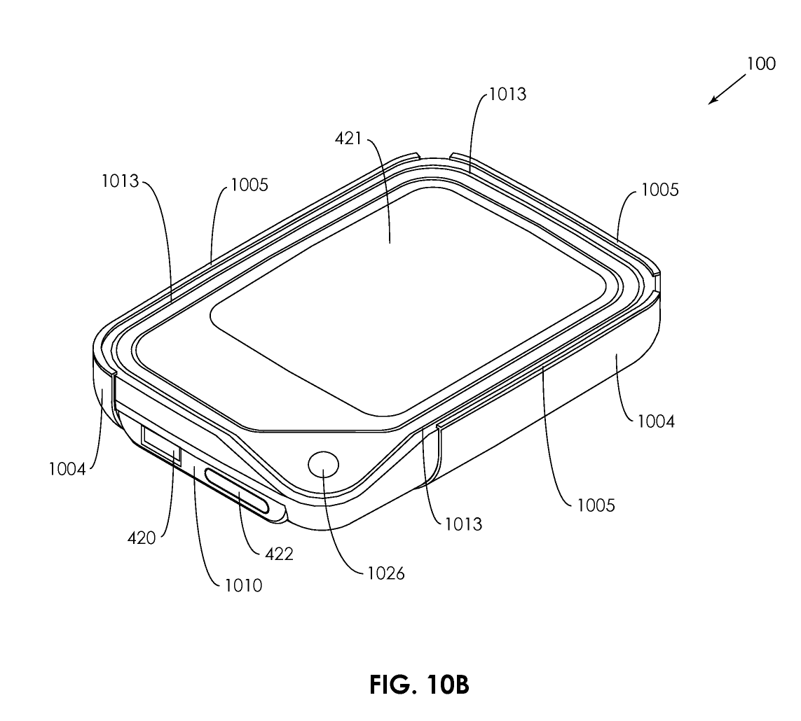

FIG. 10A-10B illustrate perspective views of a base module and attachment module separated and removably coupled, respectively, according to some aspects. As shown, analyte monitoring device 100 includes base module 101 and attachment module 102. In the example shown in FIGS. 10A-10B, instead of sliding into attachment module 102, as in the case of FIGS. 9A-9B, the base module 101 is pressed into attachment module 102, as represented by the directional arrow D shown in FIG. 10A.

Base module 101 is shown having a display 421 (e.g., touchscreen display), strip port unit 420, a communication connector unit 422 (e.g., USB port), and input element 1026 (e.g., power button). Furthermore, base module 101 is shown having a housing 1011 that includes a top outer surface 1013, as well as a surface 1010 at one end of the module 101.

Attachment module 102 is shown to include a housing base 1003 that houses circuitry 423 included in the attachment module, as represented generally by the dotted lines for circuitry 423. Circuitry 423 may include, for example, a wireless communication module for communicating wirelessly using RF (e.g., RFID technology) to a remote device such as a GoD device and/or CGM device. Furthermore, circuitry 423 may include a wireless communication module for communicating wireless with the base module 101 (e.g., the same or different wireless communication module used to communicate with the GoD device and/or CGM device). For example, the wireless communication module may communicate with the base module using Bluetooth® technology. In this way, when coupled, the attachment module 102 may receive data (e.g., glucose readings) wirelessly from the GoD and/or CGM device and provide the information to the base module 101.

Housing arms 1004, 1005 are shown extending from housing base 1003 and include protrusions 1006, 1009, respectively. Housing arms 1004, 1005 function to secure the attachment module 102 to the base module 101. The attachment module 102 is configured to include cut outs 1090 between housing arms 1004 such that housing arms 1004 can flex outward. As base module 101 is pressed downward against protrusions 1005, the curved shape of housing 1011 pushes the housing arms 1004 and protrusions 1005 outward so that base module 101 may be pushed further into the cavity formed by the housing arms 1004. Once the base module 101 is fully inserted, the protrusions 1005 pass the outer top surface 1013, thus allowing the housing arms 1004 and protrusions 1005 to flex back inward to secure the base module 101 to the attachment module 102, as shown in FIG. 10B. To release the attachment module 102 from the base module 101, the user may, for example, pull the exposed corner of the base module 101 (i.e., the corner shown with power button 1026) out of the cavity formed by the housing arms 1004. This applies force to the housing arms 1004 and protrusions 1005, thus causing them to flex outward and allow the base module 101 to be release from the attachment module 102.

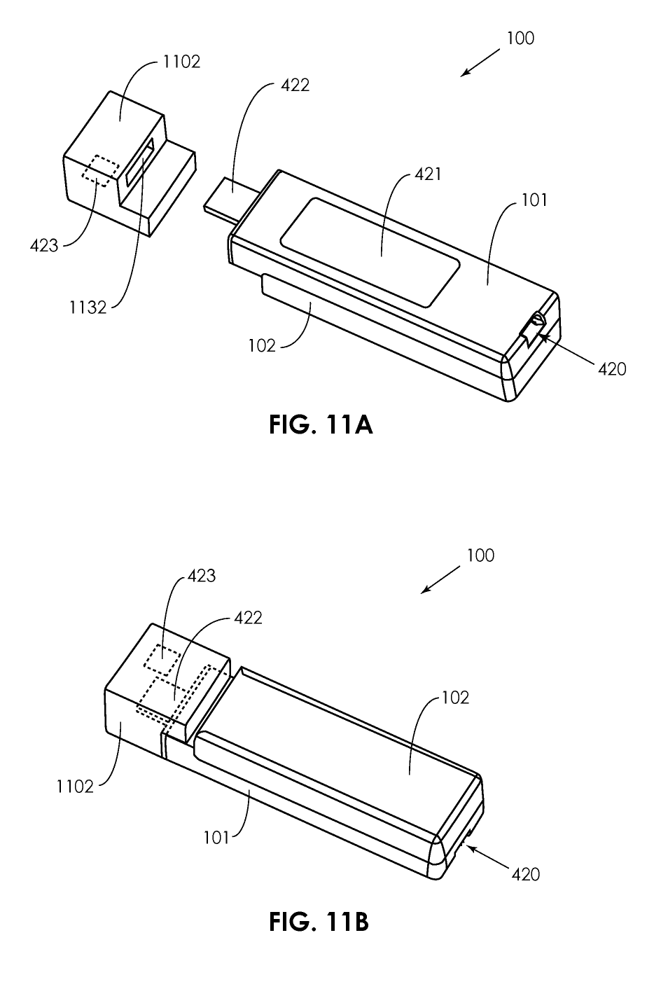

FIGS. 11A-11B illustrate perspective views of a base module and attachment module separated and removably coupled, respectively, according to some aspects. As shown, analyte monitoring device 100 includes base module 101 which removably couples to two attachment modules 1102, 102. Base module 101 is shown including a display 421 (e.g., touchscreen display) and strip port unit 420.

Base module is further shown coupled to a first attachment module 102 in both FIGS. 11A-11B. Attachment module 102 may be removably coupled to the base module in a similar manner as described in the earlier figures. The second attachment module 1102 is shown separated and coupled to base module 101 in FIGS. 11A and 11B, respectively. The second attachment module 1102 removably couples to the communication connector unit 422 (e.g., a USB connector) included on base module 101. Attachment module 1102 is shown to include a mating unit 1132 (e.g., USB port) which mates with communication connector unit 422 to allow communication between the attachment module 1102 and base module 101.

Attachment module 1102 is shown to further include circuitry 423, as represented generally by the dotted lines for circuitry 423. Circuitry 423 may include, for example, a wireless communication module for communicating wirelessly using RF (e.g., RFID technology) to a remote device such as a GoD device and/or CGM device. In this way, when coupled, the attachment module 102 may receive data (e.g., glucose readings) wirelessly from the GoD and/or CGM device and provide the information to the base module 101 via the communication connector unit 422 and mating unit 1132.

To couple the attachment module 1102 and base module 101, the two modules 101, 1102 are brought together such that the communication connector unit 422 mates with the mating unit 1132. In the example shown, the attachment module 1102 and base module 101 are form fitted and dimensioned to provide a slim profile and secure fit when the communication unit 422 is mated with the mating unit 1132. To release the attachment module 1102 from the base module 101, the user simply pulls the two modules 101, 1102 apart.

Additional description of glucose-on-demand devices and/or systems can be found in US Patent Application Publication Nos. 2008/0319296, 2009/0054749, 2009/0294277, 2008/0319295; in U.S. patent application Ser. Nos. 12/393,921, filed Feb. 26, 2009, and entitled “Self-Powered Analyte Sensor”; and 12/625,524, filed Nov. 24, 2009, and entitled “RF Tag on Test Strips, Test Strip Vials and Boxes”; and in U.S. Provisional Patent Application Nos. 61/247,519, filed Sep. 30, 2009, and entitled “Electromagnetically-Coupled On-Body Analyte Sensor and System”; 61/155,889, filed on Feb. 26, 2009, and entitled “Analyte Measurement Sensors And Methods For Fabricating The Same”; 61/238,581, filed on Aug. 31, 2009, and entitled “Analyte Monitoring System with Electrochemical Sensor”; 61/163,006, filed on Mar. 24, 2009, and entitled “Methods Of Treatment And Monitoring Systems For Same”; 61/247,508, filed on Sep. 30, 2009, and entitled “Methods and Systems for Calibrating On-Demand Analyte Measurement Device”; 61/149,639, filed on Feb. 2, 2009, and entitled “Compact On-Body Physiological Monitoring Devices and Methods Thereof”; and 61/291,326, filed on Dec. 30, 2009, and entitled “Ultra High Frequency (UHF) Loop Antenna for Passive Glucose Sensor and Reader”; the disclosures of each which are incorporated by reference herein.

Referring back to FIG. 5, in some instances, remote device 505 is a drug administration unit used to deliver drugs (e.g., insulin) to a patient (e.g., a diabetic) based on the analyte (e.g., glucose) level measured. The drug administration unit may be used for administrating a dose of medication, such as insulin, into a patient based on a prescribed medication dosage, and may be automatically updated with dosage information received from analyte monitoring device 100. In another aspect, the medication dosage of the drug administration unit may include manual entry of dosage changes made through, for example, optional input elements (not shown) coupled to the housing of analyte monitoring device 100. Medication dosage information associated with the medication delivery system may be displayed on display unit 421 disposed on analyte monitoring device 100.

Additional information regarding medication delivery devices or systems, such as, for example, integrated systems, are provided, for example, in U.S. Pat. No. 6,175,752; U.S. Patent Application Publication No. US1006/0224141, published on Oct. 5, 1006, titled “Method and System for Providing Integrated Medication Infusion and Analyte Monitoring System”; and U.S. Patent Application Publication No. US1004/0254434, published on Dec. 16, 1004, titled “Glucose Measuring Module and Insulin Pump Combination,” the disclosure of each of which is incorporated by reference herein.

In some aspects, the base module and/or attachment module as described herein may be configured to include an integrated pedometer. The analyte monitoring device may be configured, for example, to physically engage and communicate electronically with a commercially available pedometer device. The pedometer device may be positioned completely within the housing of the base module and/or attachment module. Alternatively, the pedometer device may engage, e.g., via snap-fit engagement, to a portion of the housing. The pedometer device may be an electromechanical activity monitor or may utilize global positioning system (GPS) technology. In some instances, the pedometer functionality may be provided by an attachment module (e.g., pedometer and program update for operating with the pedometer stored therein) configured to engage the base module.

As an alternative to a physically integrated pedometer, the analyte monitoring device may be configured to communicate with, e.g., via wired or wireless technology, and receive data from an external pedometer device which is not physically integrated with the analyte monitoring device. For example, this may occur via the communication connector unit or the wireless communication module.

Where the analyte monitoring device is physically integrated with or otherwise configured to communicate with a pedometer device, the analyte monitoring device may include software and/or firmware designed to receive, store, analyze, display and/or communicate data received from the pedometer device. In some aspects, such software and/or firmware may be stored on an attachment module and configured to be run by an analyte monitoring device processor on the base module that is in communication with the attachment module.

Software and/or firmware which may be utilized include software and/or firmware designed to measure and/or display daily activity information for a user of the analyte monitoring device, e.g., miles walked, stairs climbed, etc. Additional software features may include intensity of activity measurement (e.g., corresponding to the rate of user activity); daily, weekly and/or monthly activity targets which may be set by the user or a health care professional; display of current and/or previous activity level with respect to a targeted activity level; historical log of daily activity level (e.g., including trending information); integration with a health management system as described herein; and/or automatic logging of exercise data.

The base module and/or attachment module may include an integrated bar code reader. In addition, the base module and/or attachment module may be configured to include, e.g., in a data storage unit, a database which links a product's bar code to its nutritional content (e.g., its carbohydrate content). In addition to carbohydrate information, the database may include additional information, e.g., calorie information, which may be selected by a patient for entry. Alternatively, such a database could be stored on a remote device and/or system which may be accessed by the analyte monitoring device or portable electronic processing device, e.g., using a wireless communication module as described herein. In this manner, when a user scans a bar code associated with a food item he or she intends to consume, the nutritional information (e.g., carbohydrate content), can be automatically entered into an event log and/or database for later analysis.

The base module and/or attachment module may include a digital camera technology, e.g., a digital camera incorporated into the attachment module or base module to capture a digital image of a food item to be consumed. Such digital images may then be compared to images of food items having a known nutritional content, e.g., using image recognition technology.

### Algorithms and Meter Related Functions

Analyte monitoring device may be configured to perform various algorithms and various meter-related functions). Software and/or firmware for implementing the various algorithms may be stored within a machine-readable storage medium (e.g., flash memory or other non-volatile memory) and executed by one or more general-purpose or special-purpose programmable microprocessors and/or microcontrollers. Referring to FIGS. 3 and 7 (FIG. 7 described in detail below), for example, instructions may be stored in memory unit 315 and/or memory unit 350 and executed by control unit 310 and/or control unit 705.

In some aspects, software and/or firmware instructions associated with algorithms and meter-related functions are stored in attachment module 102 and are included within the program update to be transmitted to base module 101 (e.g., stored in memory unit 315). The analyte monitoring device may then subsequently operate with the new firmware and/or software. In this way, attachment modules may be manufactured with various features (e.g., algorithms and meter-related functions) that the base module does not have, providing the meter with additional capabilities.

Example algorithms and meter-related functions may be associated with, but are not limited to, the following data management applications (discussed here relevant to diabetes management for illustrative purposes):

Creating an event log—For example, various events (e.g., measurement readings, nutritional intake information such as carbohydrate intake, caloric intake, insulin dosage and times, exercise records, meal-time records, note records, medication-time records, etc.) may be recorded along with date/time tags. Events may be recorded automatically by the analyte monitoring device (e.g., upon measurement reading). Alternatively, or in addition, input elements on the analyte monitoring device may be used by a user to input event data and/or non-event data.

In some aspects, a processing unit of an analyte monitoring device or another portable electronic processing device is configured to prompt a user to enter the delivery time of a medication dosage, e.g., a medication dosage calculated by the processing unit. For example, following a bolus dosage calculation, e.g., an insulin bolus dosage calculation, the processing unit may automatically prompt the user, e.g., using the display unit, to enter the time at which the calculated bolus dosage was administered.

In some aspects, entry of carbohydrate intake data may be facilitated by providing for the utilization of bar code scanner technology in combination with a database which links product bar codes to carbohydrate information for the product. For example, an analyte monitoring device such as an analyte monitoring device as described herein or another portable electronic processing device may include an integrated bar code reader (e.g., positioned on the base module or attachment base module). In addition, the analyte monitoring device or portable electronic processing device may be configured to include, e.g., in a data storage unit, a database which links a product's bar code to its nutritional content (e.g., its carbohydrate content). In addition to carbohydrate information, the database may include additional information, e.g., calorie information, which may be selected by a patient for entry. Alternatively, such a database could be stored on a remote device and/or system which may be accessed by the analyte monitoring device or portable electronic processing device, e.g., using a wireless communication module as described herein. In this manner, when a user scans a bar code associated with a food item he or she intends to consume, the nutritional information (e.g., carbohydrate content), can be automatically entered into an event log and/or database for later analysis.

In another aspect, where a bar code and/or corresponding nutritional information are not available, a user may utilize digital camera technology, e.g., a digital camera incorporated into an analyte monitoring device (e.g., on the attachment module or base module) or another portable electronic processing device to capture a digital image of a food item to be consumed. Such digital images may then be compared to images of food items having a known nutritional content, e.g., using image recognition technology. Alternatively, or in addition, such digital images may be utilized, e.g., by a health care professional, in connection with user training designed to assist the user in assessing the carbohydrate content of a food item.

In some aspects, an analyte monitoring device, portable electronic processing device, and/or health management software may be configured to enable a user to “tag” or link one or more bar code readings or digital images with additional information entered by the user, e.g. information related to a subsequent analyte measurement or measurements.

Visually representing data—For example, data collected may be represented visually to the user (e.g., on the display unit of the analyte monitoring device and/or remote device). Data from the event log may be presented in various formats and/or further manipulated and presented. Data may be used to generate graphs and reports that help a user such as a diabetic to track glucose and other related information. The test data may be graphed in many ways according to helpful default or pre-programmed graphs or according to filtering and preferences inputs from a user. The graphs may be generated and displayed on the analyte monitoring device and/or remote device—e.g., a remote device configured to communicate with the analyte monitoring device.

Remote devices may also be configured for printing the graphs and/or reports resulting from the logging database. The remote device may be configured to take data from the logging database and put them into a logging database of its own. The remote device would be helpful for backing-up data and for downloading applications programs to the analyte monitoring device and also for communicating with other computers over one or more networks—e.g., for viewing of data by a user, patient, physician, and/or third party.

Calculating trends—For example, data from the event log may also be used to perform trending calculations. Analyte monitoring device may be capable of displaying a graph of the analyte level over a period of time. Examples of other graphs that may be useful include graphs of the rate of change or acceleration in the rate of change of the analyte level over time (i.e., trending data). Trending data may be used by other applications—e.g., in bolus calculations and/or alerts.

Trending data may also be presented via display unit on analyte monitoring device. The display unit may contain symbols or other indicators that are activated under certain conditions (e.g., a particular symbol may become visible on the display when a condition, such as hyperglycemia, is indicated by signals from the sensor). Other indicators may be activated in the cases of hypoglycemia, impending hyperglycemia, impending hypoglycemia, etc.

Additional information regarding the use of logs and trending by analyte monitoring devices can be found within U.S. Pat. Nos. 7,041,468, and 6,175,752, disclosures of which are incorporated herein by reference.

Determining alerts, alarms, and/or reminders—For example, a determination of an alert may be performed by the analyte monitoring device and conveyed to the user. An alarm may be activated if the sensor readings, for instance, indicate a value that is beyond a measurement range of the sensor. For glucose, the physiologically relevant measurement range is typically about 50 to 250 mg/dL, preferably about 40-300 mg/dL and ideally 30-400 mg/dL, of glucose in the interstitial fluid.

An alarm system may also, or alternatively, be activated when the rate of change or acceleration of the rate of change in analyte level increase or decrease reaches or exceeds a threshold rate or acceleration—e.g., to indicate a hyperglycemic or hypoglycemic condition is likely to occur.

An alarm system may be configured to activate when a single data point meets or exceeds a particular threshold value. Alternatively, the alarm may be activated only when a predetermined number of data points spanning a predetermined amount of time meet or exceed the threshold value. As another alternative, the alarm may be activated only when the data points spanning a predetermined amount of time have an average value which meets or exceeds the threshold value.

The alarm system may contain one or more individual alarms. Each of the alarms may be individually activated to indicate one or more conditions of the analyte. The alarms may be, for example, auditory or visual. Other sensory-stimulating alarm systems may be used including alarm systems which heat, cool, vibrate, or produce a mild electrical shock when activated.

In some aspects, the present disclosure provides software and/or firmware configured to perform one or more active scheduling algorithms. An active scheduling algorithm can provide a user of a base module a recommended time and/or date for a subsequent therapy administration (e.g., by displaying such information on display 421 of base module 101), wherein the recommended time and/or date is determined based on a retrospective analysis of previously administered therapies as compared to a recommended therapy sequence and/or profile. As used herein, the term “therapy” includes analyte measurement as well as the administration of a medication.

The therapy reminders can be determined and configured by a qualified health care provider, such as a physician, clinical specialist or nurse. A base module 101 can then be configured with an appropriate scheduling algorithm directly by the health care provider using an optional input unit incorporated into the base module 101, via a data management system that interfaces with the base module 101, and/or via another portable device configured to communicate with the base module 101. In this manner, a health care provider can update therapy recommendations electronically and communicate the therapy recommendations to an end user.

In some aspects, a suitable scheduling algorithm provides a reminder to the user based on an analysis of the history of analyte measurements, e.g., blood glucose measurements, made by the user and compared to scheduled analyte measurements yet to be completed. The scheduling algorithm updates the reminder during the course of the day, such that the user is presented with the next scheduled time conforming to the scheduling profile. The dynamic scheduling can continue over multiple days until the user has completed all measurements conforming to the schedule. After the therapies are completed according to the recommended schedule, the scheduling algorithm can be configured to reset and start again, or alternatively a different scheduling algorithm may be activated.

The scheduling algorithm can be configured to provide feedback to the user at any time during the scheduled therapy administration period. For example, the scheduling algorithm can be configured to provide the user with an indication of how much of the schedule has been completed, and/or how many recorded measurement times did not conform to the recommended measurement time profile.

A non-limiting example of a dynamic scheduling procedure according to the present disclosure is as follows: (A) The measurement profile is defined to include the recording of 7 analyte readings before and after lunch, with 30 minute separation, starting at 1 hour prior to lunch (11:00 am). The recommended times are 11:00 am, 11:30 am, 12:00 pm, 12:30 pm, 1:00 pm, 1:30 pm, and 2:00 pm. (B) If the user's first analyte measurement is at 12:00 pm, the algorithm would recommend that the next measurement be performed at 12:30 pm. (C) If the user does not perform an analyte measurement at 12:30 pm, the algorithm would suggest 1:00 pm, and so on. (D) If the user does perform an analyte measurement later in the day, e.g., 8:00 pm, this measurement is not considered as advancing the completion of the measurement profile. (E) If the user on the second day performs an analyte measurement at 12:00 pm, this measurement is also not considered as advancing the completion of the measurement profile, as it was already completed on the previous day. (F) If the user on the second day then samples at 1:00 pm, this measurement is considered to advance the completion of the measurement profile. Based on the above, the base module would display a summary report that 29% (2/7) of the therapy reminders have been completed, and that 2 of the 4 readings did not conform to the scheduled reminders. (G) In addition, the analyte monitoring device would report the outstanding measurement times, e.g., 11:00 am, 11:30 am, 12:30 pm, 1:30 pm and 2:00 pm.

Perform therapy management (e.g., a medication dosage calculation, etc.)—For example, the analyte monitoring device may be configured to perform a medication dosage calculation such as a single-dose calculation function for administration of rapid acting insulin and/or long acting insulin. In some instances, the analyte monitoring device with a medication dose calculation function may be configured to store the glucose data even in the event the user selects to perform the medication dose calculation. Additional information regarding analyte monitoring devices which include medication dosage calculation functions and methods of performing the dosage calculation functions are described, for example, in U.S. patent application Ser. No. 11/396,182, filed Mar. 31, 2006, titled “Analyte Monitoring Devices and Methods Thereof,” the disclosure of which is incorporated by reference herein.

In some aspects, a control unit is configured to perform a bolus calculation function. For example, the control unit may be configured to determine a bolus dosage, e.g., an insulin bolus dosage, based on the signal received from the test strip. A wizard may be implemented to facilitate the process for the user.

In some aspects a control unit is configured to perform an algorithm to determine a medication dosage based on a determined concentration of analyte. The analyte monitoring device may be configured to automatically enter into a medication dosage calculation mode to, for example, calculate and/or select a medication dosage amount based on information stored in the analyte monitoring device (such as the patient's insulin sensitivity, for example), and/or prompt the patient to provide additional information, such as the amount of carbohydrate to be ingested by the patient for determination of, for example, a carbohydrate bolus dosage determination. The patient may operate input elements and/or touchscreen to provide the appropriate information. In addition to carbohydrate information, a food database may include additional information, e.g., calorie information, which may be selected by a patient for entry.

In some aspects, the analyte monitoring device may be configured to prompt the patient to select whether to retrieve a predetermined or preprogrammed medication dosage amount such as, for example, a correction bolus or a carbohydrate bolus, following the display of the determined analyte concentration from the sample. In this manner, in some aspects of the present disclosure, analyte monitoring device may be configured to automatically prompt the user or patient to select whether a medication dosage determination is desired following analyte testing.

In some aspects, an analyte monitoring device according to the present disclosure is configured to provide the user, e.g., automatically or in response to a user input, information which describes how a particular dosage recommendation was calculated. Such information may include, for example, information relating to the user's target blood glucose level, information relating to carbohydrate intake, and one or more correction factors or amounts. In some aspects, one or more of the calculation parameters may be adjusted by the user. The user may then request a new recommended dosage recommendation based on the adjusted parameter.

Provide bolus calculator safety features—In some aspects, a control unit of an analyte monitoring device or another portable electronic processing device is configured to provide one or more bolus calculator safety features. As discussed herein, an analyte monitoring device according to the present disclosure may be configured to communicate with and receive analyte measurements from an external analyte monitoring device and/or system, e.g., a continuous glucose monitoring (CGM) device and/or system or a “glucose on demand” (GoD) monitoring device and/or system.

Where an analyte monitoring device is configured to communicate with and receive analyte measurements from a CGM device and/or system (e.g., a device and/or system including an implanted or partially implanted analyte sensor configured to automatically measure glucose levels at predetermined intervals), the control unit may be configured to automatically (or in response to a user input) initiate a process to specifically monitor a user's glucose response to a bolus dose of insulin. For example, in some instances, the control unit is configured to provide an expected glucose profile over a period of time using a physiological model associated with one or more of the user's insulin action time, glucose trajectory, meal input data, insulin input data, exercise data, health data, and time-of-day. The process may provide a “minimum” acceptable profile where the predicted glucose has a minimum value at a predetermined low glucose safety limit. The process may also provide a “maximum” acceptable profile where the predicted glucose has a maximum value at a predetermined high glucose safety limit.

These profiles may be determined in a number of ways. For example, they may be determined by increasing and decreasing carbohydrate intake until the point that the profile limits are reached. Alternatively, meal timing or one or more of the other physiological model parameters may be varied.

The control unit may then monitor using the CGM device and/or system received real-time data to determine if it falls within the minimum and maximum profiles indicated at that point in time. If a predetermined number of glucose readings (e.g., one or more) fall outside the profile range, then the control unit can be configured to communicate an alarm and/or alert to the user and indicated that the glucose reading was lower or higher than expected. In some instances, the processing device may then communicate to the user a recommended course of action.

Additional description of glucose-on-demand devices and/or systems can be found in US Patent Application Publication Nos. 2008/0319296, 2009/0054749, 2009/0294277, 2008/0319295; in U.S. patent application Ser. Nos. 12/393,921, filed Feb. 26, 2009, and entitled “Self-Powered Analyte Sensor”; and 12/625,524, filed Nov. 24, 2009, and entitled “RF Tag on Test Strips, Test Strip Vials and Boxes”; and in U.S. Provisional Patent Application Nos. 61/247,519, filed Sep. 30, 2009, and entitled “Electromagnetically-Coupled On-Body Analyte Sensor and System”; 61/155,889, filed on Feb. 26, 2009, and entitled “Analyte Measurement Sensors And Methods For Fabricating The Same”; 61/238,581, filed on Aug. 31, 2009, and entitled “Analyte Monitoring System with Electrochemical Sensor”; 61/163,006, filed on Mar. 24, 2009, and entitled “Methods Of Treatment And Monitoring Systems For Same”; 61/247,508, filed on Sep. 30, 2009, and entitled “Methods and Systems for Calibrating On-Demand Analyte Measurement Device”; 61/149,639, filed on Feb. 2, 2009, and entitled “Compact On-Body Physiological Monitoring Devices and Methods Thereof”; and 61/291,326, filed on Dec. 30, 2009, and entitled “Ultra High Frequency (UHF) Loop Antenna for Passive Glucose Sensor and Reader”; the disclosures of each which are incorporated by reference herein.

Where an analyte monitoring device is configured to communicate with and receive analyte measurements from a GoD device and/or system (e.g., a glucose monitoring device and/or system including an implanted or partially implanted analyte sensor and requiring user initiation to receive a glucose reading), the control unit may be configured to prompt the user to obtain a glucose measurement from the GoD device and/or system at predetermined time points relative to a bolus administration, e.g., at 20 min and 45 min following the bolus administration. These measurements may then be compared to a predetermined glucose profile or profiles. If a predetermined number of glucose readings (e.g., one or more) fall outside the profile range, then the control unit can be configured to communicate an alarm and/or alert to the user and indicated that the glucose reading was lower or higher than expected. In some instances, the processing device may then communicate to the user a recommended course of action.

Bolus calculator safety features may also be incorporated into analyte monitoring devices which are not in communication with external analyte monitoring devices and/or systems, but which are instead configured for self monitoring of blood glucose (SMBG). For example, such an analyte monitoring device may include a control unit configured to issue an alarm, alert or reminder to a user to perform an additional glucose reading at a predetermined time, e.g. 5 min, following an initial glucose reading and an associated bolus calculation. This allows the control unit to determine a rate factor based on the two glucose values separated in time. This rate factor may then be taken into account by the control unit in performing a new bolus calculation or providing an adjustment to a previous bolus calculation. In some instances, the control unit may determine that an initial bolus which was fully delivered was too high and that corrective action, e.g., ingestion of carbohydrate, should be taken to avoid overdelivery.

In some instances, a portion (e.g., 70%) of the calculated bolus dose is delivered or recommended for delivery based on an initial glucose reading. Subsequently, some, all or none of the remaining portion of the calculated bolus may be delivered or recommended for delivery based on a second calculated bolus taking into account the glucose rate determined following the second glucose reading.

Additional information regarding therapy management determinations such as medication dosage calculations (e.g., bolus dosage calculations) are described in U.S. patent application Ser. No. 12/699,653, filed on Feb. 3, 2010, and U.S. patent application Ser. No. 12/699,844, filed on Feb. 3, 2010, both of which are incorporated herein by reference in their entirety.

Control a drug administration system—For example, the analyte monitoring device may be configured to control a drug administration system based on, for example, measurement readings. The analyte monitoring device may provide (or communicate with a remote device to provide) a drug to counteract the high or low level of the analyte in response to a measurement reading and/or continuous measurement reading (e.g., with an implanted sensor).

In some aspects, the control unit may be further configured to automatically prompt the user, following entry of the administration time, to enter the time at which a subsequent meal is started. Such information may then be utilized by the control unit or an external processing device to optimize future medication dosage calculations.

Implement an application programming interface (API)—For example, the analyte monitoring device may be configured to implement an API to enable interaction with other software.

Instant Messaging—The analyte monitoring device can be configured to run and/or interface with a software application which in addition to providing data display and analysis tools for health management also provides Instant Messaging (IM) functionality.

For example, in some aspects, health management software, e.g., diabetes management software, is provided which allows a health care provider using the health management software to review data related to a user's health, e.g., diabetes related data, and send comments, therapy recommendations, and/or scheduling information via IM to an interface accessible by the user. The interface could be, e.g., a user's personal computer, a portable electronic device, or an analyte monitoring device with communication functionality as described previously herein.

In some aspects, health management software, e.g., diabetes management software, is provided which allows an end user to utilize the health management software to review data related to the end user's health, e.g., diabetes related data, and send comments, questions, and/or analyte measurement results via IM to an interface accessible by a health care provider.

The above functionalities may be combined in a single software application such that the health care provider and the end user are capable of reviewing data related to the end user's health and communicating with each other via IM functionality built in to the software application.

Health management software having integrated, i.e., “built in”, IM functionality can also be utilized to allow communication between an end user and a customer support representative in order to provide the end user with product support information, e.g. for the software itself or an analyte monitoring device or other product utilized in connection with the health management system.

In some aspects, the health management software is configured to prompt the end user to select an IM recipient among, e.g., product support specialists; health management specialists; e.g., diabetes management specialists; and product sales specialists.

The mode of communication utilized by the IM feature of the health management software may be text-based, voice-based and/or video-based. It should be noted that responses to the IM communications need not be in real-time.

A software application configured to provide IM functionality may be stored in and/or run from an analyte monitoring device, e.g., an analyte monitoring device as described herein. Alternatively, the software application may be stored in and/or run from a processing device such as a smart phone device, PDA, server device, laptop or desktop computer.

Report Plug-In for Health-Management Software—In some aspects, the present disclosure provides a stand-alone health management software application capable of incorporating a report plug-in application which provides for full integration of new reports into the stand-alone health management software application. Such a health management software application may be stored in and/or run from an analyte monitoring device, e.g., an analyte monitoring device as described herein. Alternatively, the software application may be stored in and/or run from a processing device such as a smart phone device, PDA, server device, laptop or desktop computer.

The report plug-in application can be made available to a user at start-up of the stand-alone health management software application and/or via a menu action. For example, in some aspects, a health management software application is provided to a user with certain reports “built-in.” At a later time point, the set of built-in reports can be augmented with one or more newly published reports. The user can be made aware of the additional reports by, e.g., a message displayed upon start up of the health management software application.

In some aspects, when the new report is accepted by the user, the new report is fully integrated into the stand-alone health management software application, i.e., the new report includes all of the functionalities that are common to the existing set of reports. Such functionalities may include, e.g.: (A) inclusion of reports in existing or new dashboards, (B) relaying user event data to other application components, e.g., other reports displayed on the dashboard, (C) receiving user event data from other application components, e.g., other reports displayed on the dashboard, (D) printing of a report using the application print engine, (E) the report can be uninstalled by the user, and (F) multiple versions of the same report is supported by implementing a versioning scheme.

As used herein, the term “dashboard” is used to refer to a visualization component of a health management software application which includes multiple component reports. The health management software application may be configured to provide multiple dashboards having different combinations and or arrangement of displayed reports.

Health-management software is well known in the art and includes, e.g., the CoPilot™ Health Management System and the PrecisionWeb™ Point-of-Care Data Management System available through Abbot Diabetes Care Inc., Alameda, Ca.

In some aspects, the health management software application provided by the present disclosure is a diabetes management software application. Such an application may be configured to run one or more reports relevant to diabetes management, e.g., a diary list report, glucose modal day report, glucose line report, glucose average report, glucose histogram report, glucose pie chart report, logbook report, lab and exam record report, statistics report, daily combination view report, weekly pump review report, and an HCP group analysis report. See, e.g., the CoPilot™ Health Management system Version 4.0 User's Guide, available online at the web address located by placing “www.” immediately preceding “abbottdiabetescare.com/static/content/document/ART12542_Rev-A_US_English.pdf”, the disclosure of which is incorporated by reference herein.

Customizable Dashboards for Health Management Software—In some aspects, the present disclosure provides a stand-alone health management software application including customizable dashboards for the management of a health condition, e.g., diabetes. Such a health management software application may be stored in and/or run from an analyte monitoring device, e.g., an analyte meter as described herein. Alternatively, the software application may be stored in and/or run from a processing device such as a smart phone device, PDA, server device, laptop or desktop computer.

The health management software can be configured such that an end user can create a new dashboard, e.g., using a “Create Dashboard Wizard” functionality which presents dashboard options to a user for selection, and/or modify an existing dashboard of the health management software. In some aspects, the health management software is configured to allow an end user or health care provide to name or rename a dashboard so that it may be readily identifiable.

In some aspects, the health management software is configured such that reports contained within a particular dashboard, e.g., a user configured dashboard, are dynamically refreshed in concert, as a result of a user changing the view on any individual report contained within the dashboard. For example, if the user changes a view period for a glucose modal day report included in a dashboard, the health management software can be configured such that each of one or more additional reports included in the dashboard are refreshed using the same time period as that selected for the glucose modal day report.

Reports within a dashboard can be refreshed with the same time period (exact time alignment) or each additional report may represent a previous or subsequent time period (sequential time alignment). Additional alignment relationships are also possible.

In some aspects, the health management software is configured to allow a user to publish and/or distribute a dashboard to other users of the health management software and/or a health care provider, e.g., via an internet connection. Similarly, a health care provider could develop a dashboard and distribute the dashboard to one or more users (e.g., a primary care giver distributing a dashboard to his/her patients).

In some aspects, the health management software is configured to automatically check for updates upon launch of the application. Alternatively, or in addition, such a check may be initiated by the user. Updates can include, e.g., new dashboards developed by the manufacturer of the health management software, its business partners, or a health care provider.

Meal Intake Reminder for Diabetes Management Meters and Application Software—In some aspects, the present disclosure provides a diabetes management software application which includes a reminder algorithm for meal intake data entry.

In some aspects, the algorithm results in presentation to the user of a reminder to enter meal intake data on, e.g., an analyte monitoring device, portable processing device (e.g., smart phone, iPhone, laptop or PDA), and/or computer. Meal intake data can include, e.g., time of meal intake, meal composition, and meal-component quantification (e.g., carbohydrates in grams, servings, or bread units).

The algorithm may present the reminder based on one or more of (a) a “reminder profile” including frequency of data entry and meal content established by the user and/or by an HCP, (b) the number of data entries, and meal composition for each entry, that have already been entered within the day and within a time period, (c) a recommendation on the type of meal(s) to be consumed for the remainder of the day or time period.

In some aspects, the reminder algorithm is configured to provide a reminder to the user based on an analysis of the history of meal-intake data entries made by the user and compared to a reminder profile configured by the user or HCP.

The algorithm may generate summary results from the data entries made by the user that indicate how many days have a full set of data, how many days have partial or incomplete data, and how many days have no data at all. In addition, the algorithm may generate data associated with meal composition for each day, and generate cumulative summaries for defined time intervals (e.g., each week in the current month).

The reminder profile may be configured by the user or by a qualified health care provider, such as a physician, clinical specialist or nurse. In some aspects, where the algorithm is configured to be run on an analyte monitoring device, e.g., a glucose meter, the analyte monitoring device may be configured with the reminder profile either (a) directly by the health care provider using the meter's user interface, (b) via a data management system that interfaces with the analyte monitoring device, or (c) via another portable processing device.

The reminder algorithm may be configured to provide feedback to the user at any time regarding how many meal-intake entries have been made and how much of the schedule or reminder profile has been completed.

It should be noted that while the above reminder algorithm is discussed in the context of a meal-intake data entry reminder, additional algorithms and associated reminders may be configured for use with the analyte monitoring devices and/or health management systems described herein, e.g., analyte measurement reminders or other therapy reminders.

Recommendation for Analyte Monitor Type Based on Simulations

Recommending analyte monitor type based on simulations—In some aspects, a control unit of an analyte monitoring device is configured to recommend an analyte monitor and/or system among multiple analyte monitors and/or systems based on simulation data. Such recommendation is described in further detail in a later section.

A variety of analyte monitoring devices are known in the art, many of which includes additional components and functionalities which can be readily incorporated into the analyte monitoring devices described herein. Disclosure of such additional components and functionalities can be found, for example, in U.S. Patent Application Publication No. 2008/0119702, U.S. Patent Application Publication No. US 2008/0114280, and U.S. Patent Application Publication No. 2008/0119710, the disclosure of each of which is incorporated by reference herein.

Firmware

In some aspects, the attachment module includes a program storing component that has program updates stored therein to be transmitted to the base module so as to change the behavior of the base module and/or provide additional feature or capabilities to the base module. In some instances, the program storing component includes firmware stored therein.

In some instances, firmware stored on the attachment module may be included as a part of the “program update”. When the attachment module is removably coupled to the base module, the base module is configured to receive the program update stored in the attachment module and operate using the program update. As stated before, in some instances, the program update is stored in non-volatile memory of base module.

In some instances, the program update may include firmware for updating the firmware currently on the base module (also referred to herein as “current firmware”). The program update may add firmware, replace the entire current firmware or alternatively replace only portions of the current firmware (e.g., to fix a bug or issue; to add additional features; etc.). In some aspects, the program update may include firmware for the base module to operate using hardware components on the attachment module—e.g., a wireless communication unit.

In some instances, the program storing component includes software stored therein and included as part of the program update. The program update may provide additional software to the base module, replace current software on the base module, or replace portions of software on the base module (e.g., to fix a bug or issue, to add additional features, etc.).

FIG. 7 illustrates a block diagram of an analyte monitoring device, according to some aspects. As shown in this example, base module 101 is configured for determining an analyte level of a sample. Base module 101 comprises various hardware components associated with determining an analyte level of the sample: a control unit 310, strip port unit 420, display unit 421, memory unit 315, communication connector unit 422, and module interface unit 714. It should be appreciated that the hardware components shown on the base module 101 are shown for exemplary purposes and that one or more of the components may not be present in other instances, or for example, may be present on the attachment module instead. For example, in some instances, base module 101 may be displayless and/or a display located on the attachment module. Furthermore, additional components not shown may also be included on either module.

The strip port unit 420 includes hardware components (e.g., a test strip port, electrode contacts, and other related electronic circuitry) configured to receive and interface with a test strip at the control of control unit 310. The display unit 421 includes hardware components configured to display information to a user at the control of control unit 310. The display unit 421 may be implemented with a Liquid Crystal Display (LCD), but is not limited thereto. The display unit may also be implemented with touchscreen capabilities, in which case the display unit would also serve as an input element.

In some aspects, display unit 421 includes a graphical user interface including a plurality of menu items, wherein the display unit is configured to provide clarification with respect to the meaning of a menu item based on a user's response speed with respect to a user input for the menu item. The menu item could take any of a variety of forms, e.g., text, icon, object or combination thereof.

In some aspects, the graphical user interface includes a menu which in turn includes a plurality of selectable menu items. As a user navigates through the menu, e.g., by highlighting or scrolling through individual menu items, a menu item that is either unreadable or incomprehensible to the user could cause the user to pause over a menu item to be selected. In some aspects, a choice can be presented to the user, e.g., using a dedicated physical button on an input unit, or a soft key on the menu, that offers further explanation of the item to be selected without actually selecting the item. For example, the graphical user interface can be configured such that after a pre-determined period of time a soft key offers an explanation of the menu item to be selected, e.g., by displaying a soft key with the word “MORE”, “ADDITIONAL INFORMATION”, “EXPAND”, “MAGNIFY”, “HELP” or a variation thereof displayed thereon.

The pre-determined period of time may be based on a fixed factory preset value, a value set by the user or a health care provider, or through an adaptive mechanism based on an analysis of the user's speed of navigation from past interactions with the graphical user interface In some aspects, the pre-determined period of time is from about 5 to about 20 seconds, e.g., from about 10 to about 15 seconds.

If the offer for clarification and/or additional information is selected, e.g., by pressing the softkey, then the menu item to be selected can be displayed in a “high emphasis” mode, e.g., where the item is displayed as if a magnifying lens is held on top of the selected item. In some aspects, additional emphasis of the menu item to be selected can be provided, e.g., by making the menu item change color, blink, or increase in size to a pre-determined maximum limit.

Alternatively, or in addition to, displaying the menu item in a “high emphasis” mode, a more descriptive explanation of what the menu item is could be provided in response to the selection of the offer for clarification and/or additional information. In some aspects, the more descriptive explanation may be provided in response to the user pressing the soft key a second or additional time. In some aspects, a more descriptive explanation of the menu item is provided in the form of scrolling text. Alternatively, or in addition, a pop-up window may be displayed which provides a more detailed explanation and/or animation of the menu item's function.

In some aspects, pausing on a menu item beyond a pre-determined period of time results in display of a soft key as discussed above. Selection of the soft key by the user results in an audible communication to the user of the menu item's identity, e.g., using a built-in speaker (not shown) included in the base module. Selection of the soft key a second time results in an audible communication to the user which includes a descriptive explanation of the menu item's function.

In some aspects, rather than utilizing a dedicated hardware button or a soft key, the graphical user interface can be configured to automatically display a menu item in a “high emphasis” mode and/or display additional information regarding the menu item's function once a user has paused for a pre-determined period of time with respect to a particular menu item. In such aspects, the base module may include an optional hardware button or soft key which when depressed returns the display to a normal display mode from the “high emphasis” mode.

The communication connector unit 422 includes hardware components (e.g., USB, FireWire, SPI, SDIO ports and/or connectors and related circuitry) configured to provide operatively coupling between the base module 101 and a remote device (not shown) having an appropriately mating interface.

Memory unit 315 is shown generally to include a program storing component 320 (e.g., Flash memory, other non-volatile memory, etc.) having current firmware stored therein; additional memory 325 (e.g., volatile memory such as random access memory (RAM) and/or non-volatile).

Stored within program storing component 320 is current firmware (e.g., the original firmware installed during manufacturing, and/or previously loaded program updates) that is used to control the analyte monitoring device 100 during operation. In some aspects, the base module101 may be fully operational as a basic analyte monitoring device without the coupling of an attachment module 102. In such case, the current firmware is used for operation of the base module 101 as a basic analyte monitoring device. In some aspects, the base module 101 may not be fully operational as a basic analyte monitoring device without the coupling of attachment module 102. In such case, the current firmware may be used for operating the base module with, for example, a pre-determined default attachment module (e.g., a default attachment module manufactured and sold with the base module as an analyte monitoring device).

Additional memory 325 may be used to store various data such as, measurement readings, custom settings, user profiles, input entries from users (e.g., food intake, insulin dosage and times, etc.), etc., which may collectively be included within the term “test data” used herein. Memory unit 315 may also include program code for various user interface applications for display on display unit 421 or for use on a remote device (not shown), for example. A user interface application may, for instance, be automatically executed when the communication connector unit 422 is coupled to a remote device such that a user interface is displayed on the remote device in order to facilitate the user to perform various functions, such as downloading test data, analyzing the test data, further processing the test data, performing various algorithms, inputting input data related to various algorithms, transmitting the test data to another remote device, etc.

Memory unit 315 may also include program code for a program update process that is executed by control unit 310. The program code may be stored in memory unit 315 of the base module 101 during manufacturing, initially stored in an attachment module 102 and loaded in memory unit 315 of the base module 101, etc.

Module interface unit 714 includes hardware components configured to provide a communication channel between the base module 101 and attachment module 102 when coupled. In some aspects, the module interface unit 714 includes electrical contacts which mate with electrical contacts of a module interface unit 716 on the attachment module 102. The transmitting of the program update to the base module 101 is one example communication that may occur via the module interface units 714, 716. In other aspects, the module interface unit 714 includes hardware components for providing a wireless communication channel between the base module 101 and attachment module 102 when coupled.

The control unit 310 is configured to control the general operation of the analyte monitoring device. Control unit 310 may, for example, include a microprocessor and/or microcontroller. Control unit 310 controls the general operation of the strip port unit 420, display unit 421, communication connector unit 422, memory unit 315, and module interface unit 714. It should be understood that the control unit 310 may also control the general operation of hardware components on the attachment module (e.g., memory unit, wireless communication unit, another control unit if present, etc.).

Also shown in FIG. 7 is attachment module 102 comprising a module interface unit 716 and memory unit 350. Attachment module 102 may also comprise additional hardware components, for example, such as a wireless communication unit 340 and control unit 705 as represented by dotted lines.

Module interface unit 716 includes hardware components configured to provide a communication channel between the base module 101 and attachment module 102 when coupled. In some aspects, the module interface unit 716 includes electrical contacts which mate with electrical contacts of a module interface unit 714 on the base module. The loading of the program update on the attachment module 102 into the base module 101 is one example communication that may occur via the module interface units 714,716. In other aspects, the module interface unit 716 includes hardware components for providing a wireless communication channel between the base module 101 and attachment module 102 when the two modules are coupled. Wireless communication unit 340 includes hardware components configured to provide wireless communication capabilities, as discussed earlier.

Memory unit 350 includes program storing component 330 (e.g., Flash memory, or other non-volatile memory) for storing program updates. In some aspects, memory unit 350 may also include program code for a program update process that is loaded by the base module and executed by control unit 310. Memory unit 350 may also include instructions for various algorithms to be executed on control unit 310 and/or optional control unit 705—e.g., in program storing component 330 and/or additional memory within memory unit 350.

It should be appreciated that in some instances, the program update may be transmitted to the base module 101 for use by control unit 310 but not necessarily stored in base module 101. For example, in some instances, the base module 101 may access and execute the program update stored in memory unit 350. In some instances, program update may be transmitted to the base module 101 and temporarily stored in volatile memory such as RAM or cache memory and used by control unit 310. In some instances, the program update may be transmitted to the base module 101 and stored within non-volatile memory (e.g., program storing component 320).

Control unit 705 is configured to control one or more general operations of the attachment module and/or communicate with the base module 101. Control unit 705 may include, for example, a microprocessor and/or microcontroller. For instance, a microcontroller from the MSP430 family of microcontrollers from Texas Instruments For instance, control unit 705 may be configured to control the general operation of the wireless communication unit 340 and/or any other hardware components on the attachment module 102. In some aspects, the control unit 310 communicates directly with control unit 705 to operate the wireless communication unit 340.

In some aspects, a control unit (e.g., control unit 310) on the base module is configured to execute a program update process. The program update process may be embodied in program code stored in a memory unit (e.g., memory unit 315) and executed by the control unit. In some aspects, the program code is stored in the memory unit of the base module upon manufacturing. In some aspects, the program code is stored in memory unit 350 of attachment module and later loaded in memory unit 315 of the base module. While the program update process is described herein as executed by the base module, it should be understood that in some aspects, the program update process may be initiated by optional control unit 705 in attachment module 102. In such case, for example, control unit 705 may control the loading of the program update into memory unit 315 on base module 101.

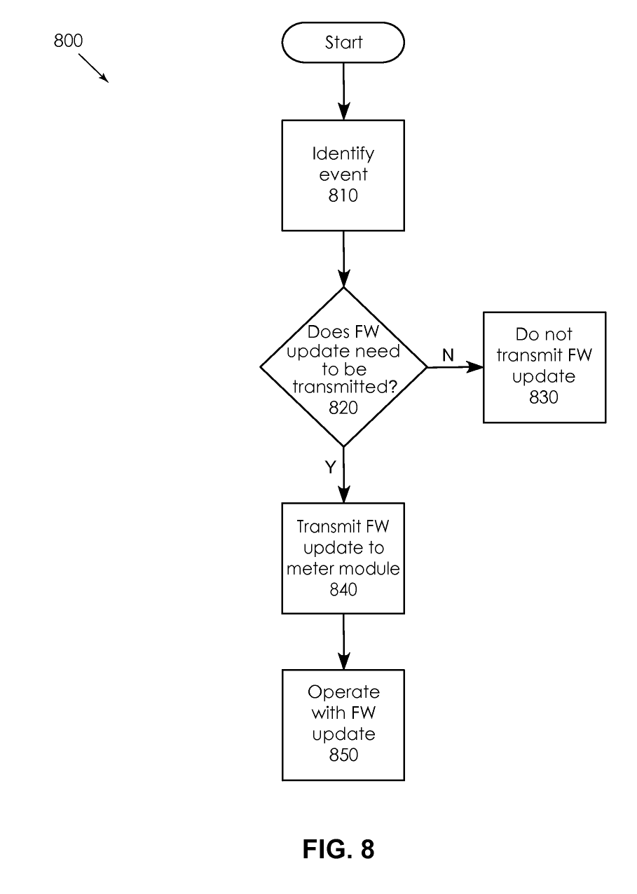

FIG. 8 illustrates a flowchart for a process of transmitting a program update, according to some aspects. At block 810, attachment module 102 is coupled to the base module 101. In some aspects, attachment module 102 may be coupled to the base module 101 while the base module is powered—i.e., hot-swappable. In other aspects, the base module may be required to be powered off before coupling an attachment module 102.

At block 810, an event is identified to initiate the program update process 800. The base module 101 may be configured to initiate a program update process 800 based on the occurrence of certain events—e.g., an indication that an attachment module has been coupled to the base module (in which case the program update process may automatically begin, transparent to the user); upon an indication of a user-prompted command; upon rebooting of the system; etc. The analyte monitoring device may also request if the program update process should begin.

At block 820, it is determined if the program update on the attachment module 102 is needed to be transmitted to the base module 101. The base module 101 may, for example, be configured to not receive program updates from the attachment module 102 if the program updates are firmware revisions that are incompatible with the base module 101; and/or firmware revisions that are older than the revision currently on the base module 101; and/or firmware incompatible for other reasons (e.g., controller type, memory type, etc., are not supported by the firmware); and/or firmware that is already encompassed in the current firmware on the base module 101 (e.g., the program update was previously received by the base module before, or a newer base module was manufactured with “newer” firmware than an older attachment module 102, etc.); etc. If it is determined that a program update is not to be transmitted to the base module 101, then the program update process is ended, as represented by block 830. The analyte monitoring device may continue with operation using the current firmware. If it is determined that the program update is to be transmitted to the base module, then continue to block 840.

At block 840, the program update is transmitted to base module 101 (e.g., loaded into program storing component 320, RAM, and/or cache memory of base module 101). For example, if the program update is to be stored in program storing component 320, the program update may replace all or part of the current firmware in base module 101. If only a portion of the current firmware is to be updated by the program update, then only that portion is rewritten. A back up of the current firmware may be made before rewriting, in case of any errors or failures in the process. In some instances, the program update process may be stored in a protected portion of memory of the memory unit 315 so that the program update process may be executed while the firmware is being rewritten or when corrupted.

At block 850, the analyte monitoring device is operated using the program update that is transmitted to base module 101 (e.g., stored in memory unit 315). The analyte monitoring device may be configured to automatically reboot the system after a successful download in order to operate using the program update loaded into memory unit 315. Alternatively, the analyte monitoring device may be configured to prompt the user to initiate the reboot. If the program update transmitted to the base module included firmware to allow the base module to operate using hardware components on the attachment module 102 (e.g., wireless communication unit 340), then the base module 101 may now operate using the wireless communication unit 340.

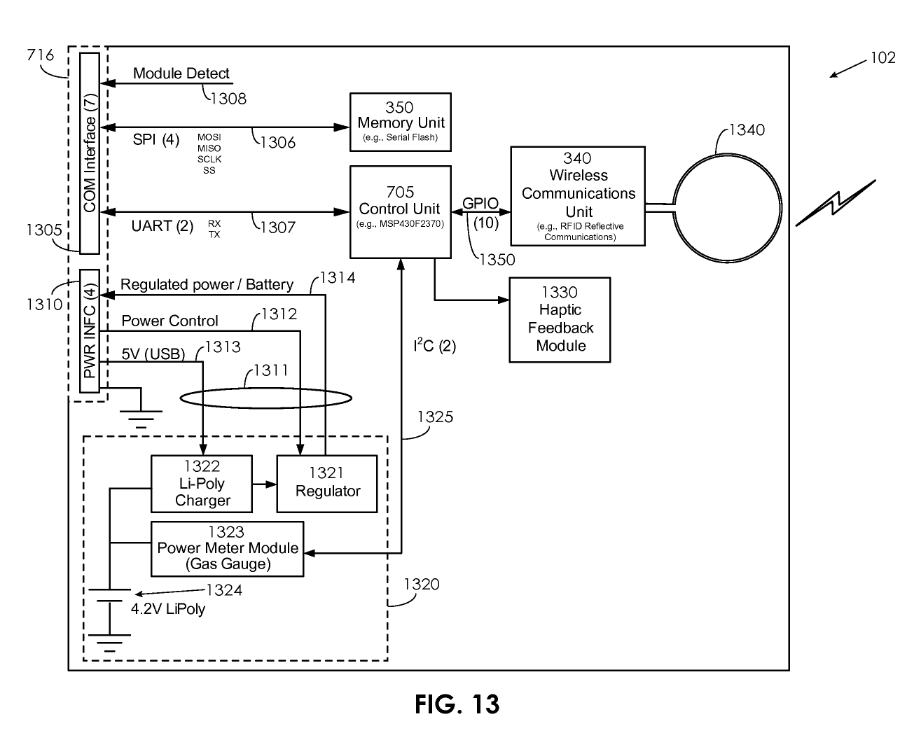

FIG. 13 illustrates a functional block diagram of an attachment module, according to some aspects. Attachment module 102 is shown comprising control unit 705, memory unit 350, wireless communication unit 340, and module interface unit 716. Control unit 705 may include a microprocessor and/or microcontroller, such as one from the MSP430 family of microcontrollers from Texas Instruments. Memory unit 350 may include non-volatile memory, such as serial flash, for example, that hosts code and bitmaps for control unit 705.

Module interface unit 716, illustrated in dotted lines, provides the communication interface between the attachment module 102 and a base module 101 (not shown). In the embodiment shown in FIG. 13, communication interface 1305 comprises a dual interface including a serial peripheral interface (SPI) bus 1306 providing data and clock lines for accessing memory unit 350, and a universal asynchronous receiver/transmitter (UART) bus 1307 providing transmit and receive lines for control unit 705. Communication interface 1305 may also include a module detect line 1308, as shown in FIG. 13, for detecting the coupling or presence of a base module. It should be understood that the dual communication interface shown is exemplary, and that various other communication interfaces could be implemented. For example, the communication interface 1305 may be implemented using another interface, such as one including a single wire and ground, or as another including a bus having 8 data lines and 16 address lines, etc.

In some instances, module interface unit 716 may also include a power interface between the attachment module 102 and a base module 101 to provide power between the two modules. For example, power may be provided to the base module 101 from the attachment module 102, and vice versa in other instances. In the embodiment shown in FIG. 13, power interface 1310 includes various power-related lines 1311 coupled to power unit 1320 illustrated in dotted lines. Power unit 1320 may include various power-related components. For example, as shown in FIG. 13, power unit 1320 includes a power source 1324 (e.g., a rechargeable lithium-ion battery) and regulator 1321 providing regulated power to the base module 101 via power line 1314 and permitting control of the power via power control line 1312. Power interface 1310 may also include a charging line 1313 coupled to power unit 1320 and used to charge the power source 1324. For example, power unit 1320 may include a lithium-ion battery charger 1322 which receives the necessary voltage and current via charging line 1313 to charge the lithium-ion battery 1324. In some instances, the charging line 1313 electrically couples the power unit 1320 to a remote power source coupled to the base module (not shown). For example, base module 101 may include a communication connector unit (e.g., a USB plug/receptacle) that couples base module 101 to a remote device such as a personal computer. When coupled, power from the remote device may be transferred to attachment module 102 via base module 101 and charging line 1313 to provide the necessary voltage and current to charge power source 1320 within power unit 1320.

In some instances, as shown in FIG. 13, power unit 1320 may also include a power meter module 1323 coupled to the power source 1324 and control unit 705. The power meter module 1323 functions as a “gas gauge” that indicates the power level of the power source 1324 to control unit 705. For instance, in the embodiment shown in FIG. 13, an inter-integrated circuit (I2C) bus 1325 is implemented between the power meter module and the control unit 705 to provide a communication interface between power meter module 1323 and control unit 705. The power meter module 1323 may communicate various power-related information to control unit 705 and receive various power-related commands from the control unit 705. For example, power meter module 1323 may communicate the remaining power of the power source 1324 to the control unit 705 at various times, such as when the power source is low, when requested by the control unit, etc. The control unit 705 may, for example, take a variety of cautionary measures (e.g., provide alerts, alarms, preventative measures, etc.) if the power level of the power source 1324 reaches one or more predetermined thresholds, and/or communicate various power-related information to the base module 101 and/or remote device.

In some instances, as shown in FIG. 13, attachment module 102 may include a haptic feedback module 1330 for providing tactile feedback to the user of the analyte processing device. For example, haptic feedback module 1330 may activate a motor or mechanical actuator to provide a vibrational effect to the analyte processing device. It should be understood that any variety of tactile feedback mechanisms may be implemented. The tactile feedback may be programmed to initiate upon the occurrence of various events. These events may relate to a wide-range of meter-related activities, readings, alerts, alarms, etc. Haptic feedback module 1330 is shown coupled to control unit 705 and receives control signals from control unit 705 when tactile feedback is to be initiated.

Wireless communication unit 340 is shown coupled to control unit 705 and, depending on the particular application, may implement various wireless communication technologies, as described herein. For example, wireless communication unit 340 may include a RFID wireless transceiver that is used to communicate with a remote device, such as for on-demand and/or continuous measurement applications described herein. In such case, for instance, antenna 1340 receives a transmitted radio signal from a remote device when the analyte processing device comes within range of the remote device, and information received from the remote device may be processed, logged, and/or conveyed to the user.

In FIG. 13, wireless communication unit 340 is shown communicatively coupled to control unit 705 via general purpose input/output (GPIO) bus 1350 to provide for the transmission of any data and control signals between the control unit 705 and the wireless communication unit 340. Again, it should be understood that the communication interfaces between components are exemplary, and other communication protocols may be implemented in other instances.

Power

The base module and attachment module may be configured to each include its own power unit supplying power to the corresponding module. In some aspects, the base module may include a power unit and the attachment module powered by the base module when coupled. In some aspects, the attachment module may include a power unit and the base module powered by the attachment module when coupled—e.g., as described in FIG. 13. In some aspects, the base module does not include a primary power unit and is operationally powered by the attachment module; however, does include a smaller back-up power unit to preserve data measurements, user settings, date/time settings, etc. The above-mentioned power units may comprise, for example, Power unit may include, batteries—e.g., button, or AAA, or other various-sized batteries. Still further, in some aspects, the base module may be powered by the remote device when coupled via the communication connector unit.

Health Management System

An analyte monitoring device as described herein can be configured to operate as one component of a health management system. For example, in some aspects an analyte monitoring device as described herein is configured to communicate, e.g., via a communication unit as described herein, with a central data repository which is in turn configured to analyze and store user-specific data in a user-specific therapy management database. The communication between the analyte monitoring device and the central data repository may be initiated by the user or may occur automatically, e.g., when the analyte monitoring device or other device is in range of a wireless network.

In some aspects, the analyte monitoring device or other device including a sensor port as described herein is one of multiple devices utilized by the user and configured to communicate with the central data repository. In such aspects, the central data repository can be configured to integrate incoming data from multiple devices. For example, the central data repository can be configured to integrate data received from one or more Personal Digital Assistants (PDAs), mobile phones, iPhones, etc. The central data repository may be located on a server and/or computer network and may include a variety of software and/or hardware components as appropriate.

The data may be transmitted from the devices in a variety of ways, e.g., via text messaging, e-mail, micro-blogging services (e.g., Twitter™), voicemail, or any other suitable messaging format. Depending on the transmission form, data may be sent by a user to, e.g., a phone number, text number, e-mail address, Twitter™ account, etc. The received data can include a variety of health related information depending on the health condition being managed. For example, in the context of diabetes, the data received by the central data repository can include, e.g., meal data, exercise data, insulin administration data, blood glucose data, blood ketone data, etc.

User-specific data received from one or more of these devices can be merged with data received from an analyte monitoring device or other device including a sensor port as described herein. Once the data is received, the central data repository interprets the message as containing, e.g., meal data exercise data, insulin administration data, blood glucose data, blood ketone data, etc., and populates the user-specific therapy management database accordingly.

The user-specific therapy management database can be configured such that it is accessible by the user, health care provider, or other suitable party, for viewing and/or editing. For example, access to the user-specific therapy management database may be provided via a website, e.g., a secure website. In some aspects, the user-specific therapy management database is hosted on a server and the system is configured such that a health care provider can access the user-specific therapy management database from a computer via a wired or wireless IP connection to the server hosting the user-specific therapy management database.

Analyte Monitoring Device with Selectively Activatable Features

Certain features and/or functionalities of the analyte monitoring device described herein may require or benefit from user-training prior to operation or use, e.g., a bolus dosage calculation function. For such features and/or functionalities, it may be an option to initially provide the analyte monitoring device with these features and/or functionalities in a disabled, but selectively activatable state. Once user-training is verified, e.g., by a health care professional, the features and/or functionalities may be activated. In other words, an analyte monitoring device may be provided with certain features and/or functionalities disabled “out of the box.”

In some instances, a user interface, e.g., a touch screen display and/or input elements of the analyte monitoring device provide a mechanism for entry of an activation code, which when entered, enables or “unlocks” one or more of the disabled features and/or functionalities. The activation code may be provided, for example, by a physician via a prescription. A unique activation code may be provided which corresponds to a serial number for a particular base module and/or attachment module. Alternatively, a single activation code may be provided which is capable of activating features and/or functionalities of multiple base modules and/or attachment modules. A manufacturer of the base module and/or attachment module may provide a service to accept and confirm a prescription of a physician and provide the activation code to a user of the base module and/or attachment module.

The activation code may be transmitted and entered into the analyte monitoring device in a number of ways. For example, a manufacturer or a manufacturer's representative may provide the code explicitly, e.g., via telephone or e-mail, to a user who then enters the code into the base module and/or attachment module using an input element of the analyte monitoring device. Alternatively, the activation code may be communicated and entered into the base module and/or attachment module from a remote location, e.g., using a communication connector unit and/or wireless communication module of the analyte monitoring device. This may occur, for example, when the analyte monitoring device is in communication with a wireless data network.

In some instances, following entry of an activation code, the analyte monitoring device displays available features and/or functionalities in a set-up menu from which a user of the analyte monitoring device can then select particular features and/or functionalities to enable. In some instances, this set-up menu can also be utilized by the user to disable particular features and/or functionalities.

The activation of particular features and/or functionalities may also be provided for based on payment of a fee or a paid subscription service. For example, a base module and/or attachment module may be provided with a variety of features and/or functionalities disabled, which features and/or functionalities may be enabled upon entry of an activation code, which activation code is provided based on payment an activation or subscription fee.

Analyte Monitoring Device Incorporated into Protective Skin or Case

In some aspects, the present disclosure provides an analyte monitoring device, for example, an analyte monitoring device as described herein, which is incorporated into a protective “skin” or case designed to fit a portable electronic processing device, e.g., a PDA, smart phone, etc. Such devices include for example, BlackBerry®, iPhone®, iPod®, and iTouch® devices as well as a wide variety of other portable electronic processing devices known in the art. Where the protective “skin” or case is designed to fit a portable electronic processing device, the analyte monitoring device itself does not need to physically engage the housing of the portable electronic processing device. Instead, the analyte monitoring device may be positioned in the protective “skin” or case such that when the protective “skin” or case is fit to the portable electronic processing device a convenient portable integrated device combination is provided. In some instances, either the base module or the attachment module may be individually positioned in the protective “skin” or case. In some instances, both may be individually positioned separately into the protective “skin” or case. In some instances, an analyte monitoring device and at least one individual base module and/or attachment module may be positioned in the protective “skin” or case. In addition, the protective “skin” or case may provide structural support for the integrated device combination.

As used herein the term “skin” refers to a flexible material, e.g., a flexible polymer material, configured to cover at least a portion of a portable electronic processing device. In some instances, a skin is sized and shaped to fit one or more external dimensions of a portable electronic processing device, while providing access to one or more features of the portable electronic processing device, e.g., one or more input units, displays, speakers, microphones, headphone jacks, cameras, communication ports, etc. For example, a skin may be configured to cover greater than 40%, e.g., greater than 50%, greater than 60%, greater than 70%, greater than 80% or greater than 90% of the exposed surface of a portable electronic device.

As used herein with reference to a portable electronic processing device, use of the term “case” as opposed to the term skin refers to a relatively rigid covering for a portable electronic processing device. As with the skin, in some instances, a case is sized and shaped to fit one or more external dimensions of a portable electronic processing device, while providing access to one or more features of the portable electronic processing device, e.g., one or more input units, displays, speakers, microphones, headphone jacks, cameras, communication ports, etc. For example, a case may be configured to cover greater than 40%, e.g., greater than 50%, greater than 60%, greater than 70%, greater than 80% or greater than 90% of the exposed surface of a portable electronic device.

The analyte monitoring device may be configured as one or more of a discrete analyte measurement device (e.g., a glucose meter configured to receive a glucose test strip), a component of an analyte measurement system including an implanted or partially implanted analyte sensor (e.g., a component of a continuous glucose measurement system), a component of an on-demand analyte measurement system and a component of a medication delivery system (e.g., an insulin delivery system including an insulin pump).

The analyte monitoring device which is incorporated into the protective skin or case is configured for one or two-way communication with a processor and/or control unit of the portable electronic processing device. The communication may be wired or wireless, e.g., using one or more of the wireless communication protocols and wireless communication modules described herein.

In specific instances, communication between processor and/or control unit of the portable electronic processing device and the analyte monitoring device is accomplished using a “wired” connection between a communication connector unit of the analyte monitoring device and a hard-wired communication port positioned on the portable electronic processing device (e.g., a USB port or a proprietary serial interface such as that found in the iPhone®). For example, the communication connector unit of the base module may include a male USB connector while the portable electronic processing device includes a corresponding female USB connector. Connection of the two connectors provides a physical and electrical connection between the base module and the portable electronic processing device.

In some instances, where the analyte monitoring device is configured as a discrete analyte measurement device, it may include a strip port, e.g., a strip port as described herein. In such instances, the discrete analyte measurement device may or may not include a display unit which is separated from a display unit of the portable electronic processing device. Where the discrete analyte measurement device does not include a separate display unit, analyte measurement results obtained using the discrete analyte measurement device may be displayed on the display unit of the portable electronic processing device.

In some instances, where the analyte monitoring device is configured as a component of an analyte measurement system including an implanted or partially implanted analyte sensor (e.g., a continuous analyte sensor), the analyte monitoring device in combination with the portable electronic processing device coupled thereto provide a portable hand-held component of the measurement system. In such instances, the analyte monitoring device may be configured to include a wireless communication module which provides for wireless, e.g., RF, communication with an on-body portion of the analyte measurement system, e.g., an implanted or partially implanted analyte sensor or an RF-powered measurement circuit coupled to an implanted or partially implanted analyte sensor.

In some instances, where the analyte monitoring device is configured as a component of an on-demand analyte measurement system, the analyte monitoring device in combination with the portable electronic processing device coupled thereto provide a portable hand-held component of the measurement system. In such instances, the analyte monitoring device may be configured to include a wireless communication module which provides for wireless, e.g., RF, communication with an on-body portion of the on-demand analyte measurement system when the portable hand-held component is positioned in proximity to the on-body portion of the on-demand analyte measurement system. In this manner, periodic or intermittent analyte readings may be obtained and communicated to a user. In some instances, a button or other input device on the analyte monitoring device may be utilized by a user to initiate the on-demand acquisition of measurement data. Alternatively, the acquisition of measurement data may be initiated using a user interface of the portable electronic processing device.

In some instances, where the analyte monitoring device is configured as a component of a medication delivery system, e.g., an insulin delivery system, the analyte monitoring device in combination with the portable electronic processing device coupled thereto provide a portable hand-held component of the medication delivery system. In such instances, the analyte monitoring device may be configured to include a wireless communication module which provides for wireless, e.g., RF, communication with a medication delivery device, e.g., an insulin pump.

In some instances, the analyte monitoring device is configured to be powered by a portable electronic processing device to which the analyte monitoring device is coupled, e.g. USB connection via the communication connector unit. Alternatively, or in addition, the analyte monitoring device may include a separate power source, e.g., a disposable or rechargeable battery. Additional information related to the powering of an analyte monitoring device coupled to a portable electronic processing device is provided in U.S. Pat. No. 7,041,468, the disclosure of which is incorporated by reference herein.

The analyte monitoring device may include a memory for storing one or more software applications designed to be uploaded and/or run by a processor or controller unit of a portable electronic processing device to which the analyte monitoring device is coupled.

Recommendation for Analyte Monitor Type Based on Simulations

In some aspects, the present disclosure provides methods for selecting for a user an analyte monitor and/or system among multiple analyte monitors and/or systems based on simulation data. CGM, GoD and SMBG analyte monitoring devices and/or systems are discussed previously herein and in the materials incorporated by reference herein. In some instances, the present disclosure provides a method for selecting a glucose monitoring device and/or system from among a CGM device and/or system, a GoD device and/or system and a SMBG device and/or system. The method includes running a simulation for each device and/or system, taking into account multiple meal and/or correction events that have been recorded for a particular user. The method utilizes glucose history, meal information and insulin delivery information in connection with these events as available for a particular device and/or system to calculate the optimal parameters specific to the user for the particular device and/or system.

For example, in some instances, a simulation for a SMBG device and/or system assumes that for each meal bolus event, the bolus is based on the meal information and the glucose level, but not on glucose trending information. In some instances, a simulation for a GoD device and/or system includes information similar to that for the SMBG device and/or system except that trending information is also taken into account for the bolus calculation. In some instances, a simulation for a CGM device and/or system assumes that whenever the glucose measurement exceeds a high or low threshold, that a correction bolus occurs based on glucose level and trending information. Alternatively, or in addition, the CGM simulation may take into account that a correction is triggered based on projected high or low thresholds. Metrics based on the simulation results may be used to provide an indication of acceptable glucose control. The method may be utilized by a health care professional in order to determine the appropriate device for a particular patient and/or user.

It should be understood that techniques introduced in the preceding can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICS), programmable logic devices (PLDs), field-programmable gate arrays (FPGAs), etc.

Software or firmware implementing the techniques introduced herein may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing took, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc. The term “logic”, as used herein, can include, for example, special purpose hardwired circuitry, software and/or firmware in conjunction with programmable circuitry, or a combination thereof.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and aspects of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary aspects shown and described herein. Rather, the scope and spirit of present invention is embodied by the appended claims.

That which is claimed is:

1. A base module for coupling to an attachment module to form an analyte monitoring device, the base module comprising:
a housing;
a strip port unit coupled to the housing;
a physical interface for removably coupling an attachment module to the base module, the base module configured to receive a program update from the attachment module when coupled.

2. The base module of claim 1, wherein the program update includes firmware for operating the base module with a hardware component on the attachment module.

3. The base module of claim 2, wherein the hardware component is a wireless communication unit.

4. The base module of claim 2, wherein the analyte monitoring device is a glucose meter.

5. The base module of claim 1, further comprising a communication connector unit for communicatively coupling to a first remote device.

6. The base module of claim 5, wherein the communication connector unit includes a USB plug that couples to a USB receptacle on the first remote device.

7. The base module of claim 6, wherein the base module is configured to transmit test data to the first remote device via the communication connector unit.

8. The base module of claim 5, wherein the base module is configured to automatically implement a user interface application on the first remote device via the communication connector unit when coupled to the first remote device.

9. The base module of claim 8, wherein the first remote device is coupled to a network via a network interface, and wherein the user interface application is configured to enable test data and/or data associated with the test data to be transmitted via the network interface to a second remote device connected to the network.

10. The base module of claim 5, wherein the first remote device is one selected from a group consisting of a personal computer, laptop, PDA, cellular phone, smartphone, and set-top box.

11. The base module of claim 1, wherein the base module is displayless.

12. The base module of claim 1, further comprising a display unit coupled to the housing.

13. The base module of claim 12, wherein the display unit includes a LCD display.

14. The base module of claim 12, wherein the display unit includes a touchscreen display.

15. The base module of claim 1, wherein the physical interface includes a module interface unit including first electrical contacts, the first electrical contacts to couple to second electrical contacts on the attachment module to provide a communication path between the base module and the attachment module, and wherein the program update is received by the base module via the communication path.

16. The base module of claim 1, wherein the program update includes firmware for operating the base module with a wireless communication unit on the attachment module.

17. The base module of claim 16, wherein the wireless communication unit includes a RF transmitter.

18. The base module of claim 16, wherein the wireless communication unit includes a transmitter using at least one protocol selected from a group consisting of Zigbee, Wibree, WiFi, infrared, wireless USB, UWB, and Bluetooth®.

19. The base module of claim 16, wherein the wireless communication unit is configured to receive a signal from a remote sensor using Radio Frequency Identification (RFID) technology.

20. The base module of claim 1, wherein the base module is configured to couple to the attachment module while powered on.

21. The base module of claim 1, wherein when the program update is received by the base module, the base module automatically reboots to begin operation using the program update.

22. The base module of claim 1, further comprising a control unit coupled to the housing, the control unit configured to execute instructions stored in a memory unit on the analyte monitoring device, the instructions for performing a medication dosage calculation.

23. The base module of claim 1, further comprising a control unit coupled to the housing, the control unit configured to execute instructions stored in a memory unit on the analyte monitoring device, the instructions for performing at least one selected from a group consisting of a medication dosage calculation, a trending calculation, and an alert determination.

24. The base module of claim 23, wherein the base module receives the instructions from the attachment module and stores the instructions in the memory unit on the base module.

25. The base module of claim 1, further comprising a power unit to power the base module and attachment module.

26. The base module of claim 1, wherein the base module is operationally powered by a power unit on the attachment module when coupled.

27. The base module of claim 1, further comprising a first power unit to power the base module, wherein the attachment module is powered by a second power unit on the attachment module.

28. The base module of claim 1, further comprising input elements coupled to the housing.

29. An attachment module for coupling to a base module to form an analyte monitoring device, the attachment module comprising:
a housing;
a physical interface for removably coupling the attachment module to the base module, the base module configured for determining an analyte level of a sample and including a strip port unit; and
a program storing component coupled to the housing, the program storing component including a program update stored therein to be transmitted to the base module when coupled.

30. The attachment module of claim 29, wherein the program storing component is flash memory.

31. The attachment module of claim 29, further comprising one or more hardware components coupled to the housing, wherein the program update includes firmware for the base module to operate using the one or more hardware components.

32. The attachment module of claim 31, wherein the one or more hardware components include a wireless communication unit.

33. The attachment module of claim 32, wherein the wireless communication unit includes a RF transmitter.

34. The attachment module of claim 32, wherein the wireless communication unit includes a transmitter using at least one protocol selected from a group consisting of Zigbee, Wibree, WiFi, infrared, wireless USB, UWB, and Bluetooth®.

35. The attachment module of claim 32, wherein the wireless communication unit is configured to receive a signal from a remote sensor using Radio Frequency Identification (RFID) technology

36. The attachment module of claim 32, wherein the wireless communication unit is configured to communicate with a first remote device.

37. The attachment module of claim 36, wherein the first remote device is one selected from a group consisting of a personal computer, laptop, PDA, cellular phone, smartphone, and set-top box.

38. The base module of claim 36, wherein the wireless communication unit is configured to transmit a user interface application for implementation on the first remote device.

39. The attachment module of claim 38, wherein the first remote device is coupled to a network via a network interface, and wherein the user interface application is configured to enable test data and/or data associated with the test data to be transmitted via the network interface to a second remote device connected to the network.

40. The attachment module of claim 29, wherein the physical interface includes a module interface unit including first electrical contacts, the first electrical contacts to couple to second electrical contacts on the base module to provide a communication path between the base module and the attachment module, and wherein the program update is transmitted by the attachment module via the communication path.

41. The attachment module of claim 29, wherein the analyte monitoring device is configured to execute instructions stored in a memory unit on the analyte monitoring device, the instructions for performing a medication dosage calculation.

42. The attachment module of claim 29, wherein the analyte monitoring device is configured to execute instructions stored in a memory unit on the analyte monitoring device, the instructions for performing at least one selected from a group consisting of a medication dosage calculation, a trending calculation, and an alert determination.

43. The attachment module of claim 42, wherein the attachment module transmits the instructions from the attachment module to the base module for storage in a memory unit on the base module.

44. The attachment module of claim 29, wherein the attachment module is configured to couple to the base module while the base module is powered on.

45. The attachment module of claim 29, wherein when the program update is transmitted to the base module for storage, the base module begins operation using the program update after the base module reboots.

46. The attachment module of claim 29, further comprising a power unit to power the base module and attachment module.

47. The attachment module of claim 29, wherein the base module is powered by a power unit on the attachment module when coupled.

48. The attachment module of claim 29, further comprising a first power unit to power the attachment module, wherein the base module is powered by a second power unit on the base module.

49. An analyte monitoring device comprising:
a base module comprising:
a first housing;
a strip port unit coupled to the first housing; and
a first physical interface; and
an attachment module removably coupled to the base module, the attachment module comprising:
a second housing;
a second physical interface, the first and second physical interfaces for removably coupling the attachment module to the base module; and
a program storing component coupled to the housing, the program storing component including a program update stored therein to be transmitted and to the base module when coupled.

50. The analyte monitoring device of claim 49, wherein the base module further comprises a communication connector unit for communicatively coupling to a first remote device.

51. The analyte monitoring device of claim 50, wherein the communication connector unit includes a USB plug that couples to a USB receptacle on the first remote device.

52. The analyte monitoring device of claim 50, wherein the analyte monitoring device is configured to transmit test data to the first remote device via the communication connector unit.

53. The analyte monitoring device of claim 50, wherein the analyte monitoring device is configured to automatically implement a user interface application on the first remote device via the communication connector unit when coupled to the first remote device.

54. The analyte monitoring device of claim 53, wherein the first remote device is coupled to a network via a network interface, and wherein the user interface application is configured to enable test data and/or data associated with the test data to be transmitted via the network interface to a second remote device connected to the network.

55. The analyte monitoring device of claim 49, wherein the attachment module further comprises one or more hardware components coupled to the housing, wherein the program update includes firmware for the base module to operate using the one or more hardware components.

56. The analyte monitoring device of claim 55, wherein the one or more hardware components include a wireless communication unit.

57. The analyte monitoring device of claim 56, wherein the wireless communication unit includes a RF transmitter.

58. The analyte monitoring device of claim 56, wherein the wireless communication unit includes a transmitter using at least one protocol selected from a group consisting of Zigbee, Wibree, WiFi, infrared, wireless USB, UWB, and Bluetooth®.

59. The analyte monitoring device of claim 56, wherein the wireless communication unit is configured to receive a signal from a remote sensor using Radio Frequency Identification (RFID) technology

60. The analyte monitoring device of claim 56, wherein the wireless communication unit is configured to communicate with a first remote device.

61. The analyte monitoring device of claim 60, wherein the first remote device is one selected from a group consisting of a personal computer, laptop, PDA, cellular phone, smartphone, and set-top box.

62. The analyte monitoring device of claim 49, wherein the base module further comprises a display unit coupled to the first housing, wherein the display unit includes a touchscreen display.

63. The analyte monitoring device of claim 49, wherein the analyte monitoring device is configured to execute instructions associated with an algorithm, the instructions included in the program update.

64. The analyte monitoring device of claim 63, wherein the instructions are for performing at least one selected from a group consisting of a medication dosage calculation, a trending calculation, and an alert determination.

65. The analyte monitoring device of claim 49, wherein the base module is displayless.

66. The analyte monitoring device of claim 49, wherein the base module includes a display unit coupled to the housing.
